(19) United States
(12) Patent Application Publication
(10) Pub. No.: US 2024/0187135 A1
(43) Pub. Date: Jun. 6, 2024

(54) SPACE-FREQUENCY PRECODING FOR HYBRID FREQUENCY MULTI-HOP LINKS WITH LINE-OF-SIGHT MULTIPLE-INPUT AND MULTIPLE-OUTPUT ON AN INTERMEDIATE HOP

(71) Applicant: QUALCOMM Incorporated, San Diego, CA (US)

(72) Inventors: David YUNUSOV, Holon (IL); Michael LEVITSKY, Rehovot (IL); Assaf TOUBOUL, Netanya (IL)

(21) Appl. No.: 18/074,434

(22) Filed: Dec. 2, 2022

(51) Int. Cl. H04L 1/06; H04B 7/0456; H04L 5/00

(52) U.S. Cl. CPC H04L 1/0606; H04B 7/0456; H04L 5/0012

(57) ABSTRACT

In an aspect, a wireless device precodes data based on a space-frequency precoding scheme across a plurality of spatial ports and virtual ports based on frequency over which the data is to be transmitted, and transmits, to a repeater, the space-frequency precoded data via the plurality of spatial ports and layers associated with the virtual ports. In another aspect, the wireless device receives a signal from a repeater comprising data precoded based on a space-frequency precoding scheme across a plurality of spatial ports and virtual ports, and derives separate virtual data streams by applying space-frequency minimum mean square error (MMSE) combining of the received signal across multiple reception ports.

### TECHNICAL FIELD

The present disclosure relates generally to communication systems, and more particularly, to wireless communications utilizing a sub-terahertz (sub-THz) frequency band.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a transmitter. The apparatus may include memory and at least one processor coupled to the memory. Based at least in part on information stored in the memory, the at least one processor may be configured to precode data based on a space-frequency precoding scheme across a plurality of spatial ports and virtual ports based on frequency over which the data is to be transmitted, and transmit, to a repeater, the space-frequency precoded data via the plurality of spatial ports and layers associated with the virtual ports.

In another aspect of the disclosure, a method, a computer-readable medium, and an apparatus are provided for wireless communication at a receiver. The apparatus may include memory and at least one processor coupled to the memory. Based at least in part on information stored in the memory, the at least one processor may be configured to receive a signal from a repeater comprising data precoded based on a space-frequency precoding scheme across a plurality of spatial ports and virtual ports, and derive separate virtual data streams by applying space-frequency minimum mean square error (MMSE) combining of the received signal across multiple reception ports.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a deployment for sub-terahertz (sub-THz) bands, in accordance with various aspects of the present disclosure.

FIG. 5 is a diagram illustrating a deployment for Sub-THz bands that utilizes hybrid frequency multi-hop links with line-of-sight (LOS) multiple-input multiple-output (MIMO), in accordance with various aspects of the present disclosure.

FIG. 6 is a diagram that depicts an example hybrid frequency multi-hop link architecture, in accordance with various aspects of the present disclosure.

FIG. 7 is a diagram illustrating a hybrid band multi-hop link with LOS MIMO, in accordance with various aspects of the present disclosure.

FIG. 8 is a diagram illustrating a representation of a signal transmitted by the network node and received by a UE, in accordance with various aspects of the present disclosure.

FIG. 9 is a diagram illustrating a precoding matrix utilized for space-frequency precoding performed by a transmitting device, in accordance with various aspects of the present disclosure.

FIG. 10 is a diagram illustrating a precoding operation performed for a particular virtual port, in accordance with various aspects of the present disclosure.

FIG. 11 is a call flow diagram illustrating a method of wireless communication in accordance with various aspects of this present disclosure.

FIG. 12 is a call flow diagram illustrating a method of wireless communication in accordance with various aspects of this present disclosure.

FIG. 13 is a flowchart illustrating methods of wireless communication at a wireless device in accordance with various aspects of the present disclosure.

FIG. 14 is a flowchart illustrating methods of wireless communication at a wireless device in accordance with various aspects of the present disclosure.

FIG. 15 is a flowchart illustrating methods of wireless communication at a wireless device in accordance with various aspects of the present disclosure.

FIG. 16 is a flowchart illustrating methods of wireless communication at a wireless device in accordance with various aspects of the present disclosure.

FIG. 17 is a flowchart illustrating methods of wireless communication at a wireless device in accordance with various aspects of the present disclosure.

FIG. 18 is a flowchart illustrating methods of wireless communication at a wireless device in accordance with various aspects of the present disclosure.

FIG. 19 is a flowchart illustrating methods of wireless communication at a wireless device in accordance with various aspects of the present disclosure.

FIG. 20 is a diagram illustrating an example of a hardware implementation for an example apparatus and/or network entity.

FIG. 21 is a diagram illustrating an example of a hardware implementation for an example network entity.

FIG. 22 is a diagram illustrating an example of a hardware implementation for an example network entity.

### DETAILED DESCRIPTION

Various aspects relate generally to wireless communication and more particularly to space-frequency precoding for communication via hybrid frequency multi-hop links. The multi-hop links may be implemented utilizing line-of-sight (LOS) multiple-input and multiple-output (MIMO)-based repeaters. Some aspects more specifically relate to performing space-frequency precoding and combining at the transmit and receive edges (e.g., at the network node or user equipment (UE) rather than at the repeaters). For instance, when transmitting a data signal, the network node, as one example of a transmitter, may precode the data signal based on a space-frequency precoding scheme across a plurality of spatial ports and virtual ports based on a first frequency bandwidth (e.g., a sub-THz frequency bandwidth) over which the data is to be transmitted. The network node may transmit the space-frequency precoded data signal to a first repeater via the plurality of spatial ports and virtual ports. The first repeater may forward the space-frequency precoded data signal to a second repeater over a second frequency bandwidth (e.g., a millimeter wave (mmW) frequency bandwidth) as an LOS MIMO signal. The second repeater may recompose the space-frequency precoded data signal back to the first frequency bandwidth and transmit the recomposed data signal to the UE over the first frequency bandwidth. The UE, e.g., as one example of a receiver, may apply space-frequency minimum mean square error (MMSE) combining across the receive ports by which the recomposed space-frequency precoded data signal is received.

Particular aspects of the subject matter described in this disclosure can be implemented to realize one or more of the following potential advantages. In some examples, by applying space-frequency precoding/combining at the transmit and receive edges rather than at the repeaters (i.e., at the intermediate hops), power intensive digital processing at the repeaters may be avoided. Accordingly, analog repeaters may be utilized instead, which consume less power. As such, the aspects described herein advantageously achieve a more power-efficient Sub-THz deployment, as overall power consumption is reduced as a result from using analog repeaters at the intermediate hops. Moreover, by applying space-frequency precoding across the spatial and frequency transmit ports and applying space-frequency combining across the spatial and frequency receive ports at the transmit and receive edges, respectively, inter-channel leakage and/or interference related to the LOS MIMO usage at the intermediate hops is mitigated.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

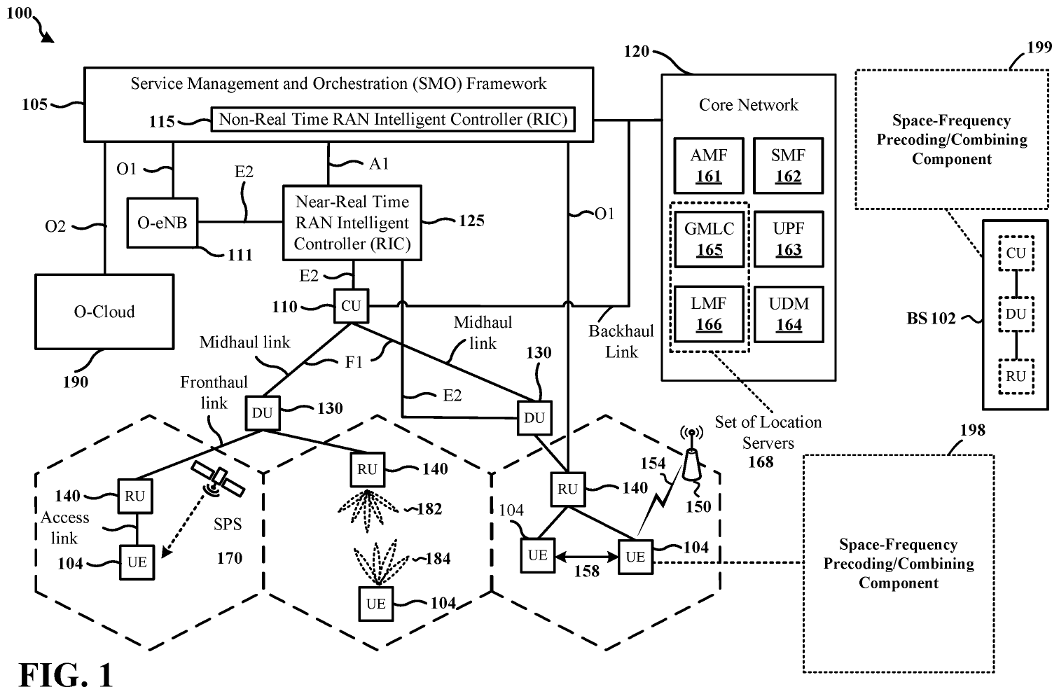

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a component 198 that may be configured to precode data based on a space-frequency precoding scheme across a plurality of spatial ports and virtual ports based on frequency over which the data is to be transmitted and to transmit, to a repeater, the space-frequency precoded data via the plurality of spatial ports and layers associated with the virtual ports. The component 198 may also be configured to receive a signal from a repeater comprising data precoded based on a space-frequency precoding scheme across a plurality of spatial ports and virtual ports and to derive separate virtual data streams by applying space-frequency MMSE combining of the received signal across multiple reception ports. In certain aspects, the base station 102 may have a component 199 that may be configured to precode data based on a space-frequency precoding scheme across a plurality of spatial ports and virtual ports based on frequency over which the data is to be transmitted and to transmit, to a repeater, the space-frequency precoded data via the plurality of spatial ports and layers associated with the virtual ports. The component 199 may also be configured to receive a signal from a repeater comprising data precoded based on a space-frequency precoding scheme across a plurality of spatial ports and virtual ports and to derive separate virtual data streams by applying space-frequency MMSE combining of the received signal across multiple reception ports. Although the following description may be focused on 5G NR, the concepts described herein may be applicable to other similar areas, such as LTE, LTE-A, CDMA, GSM, and other wireless technologies.

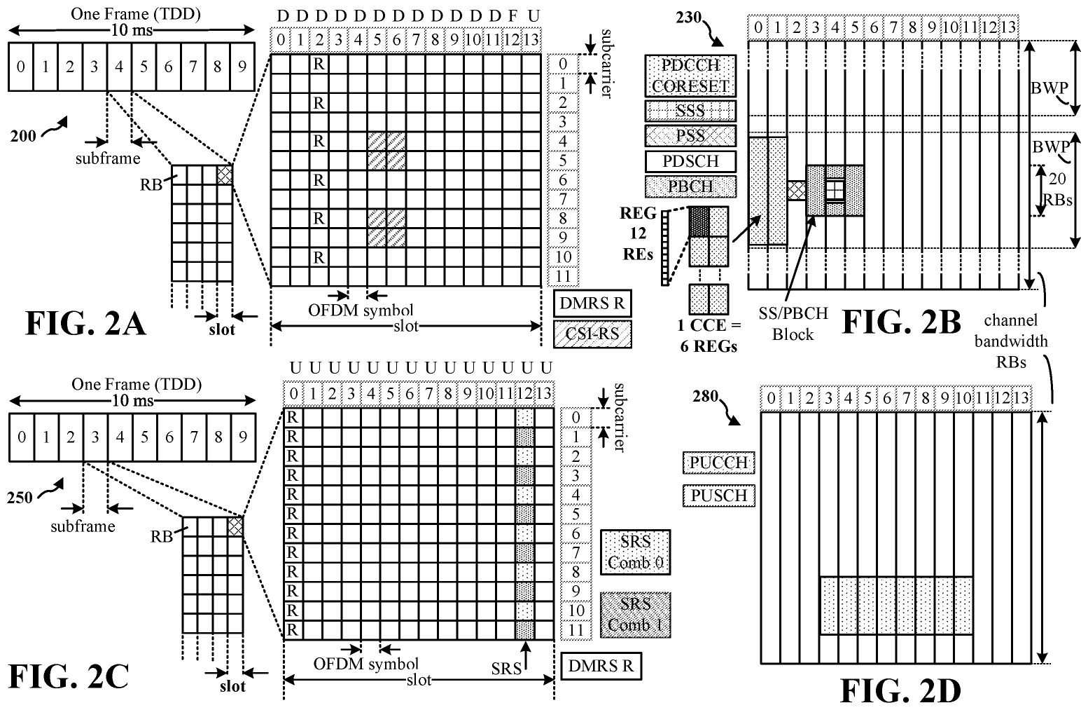

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

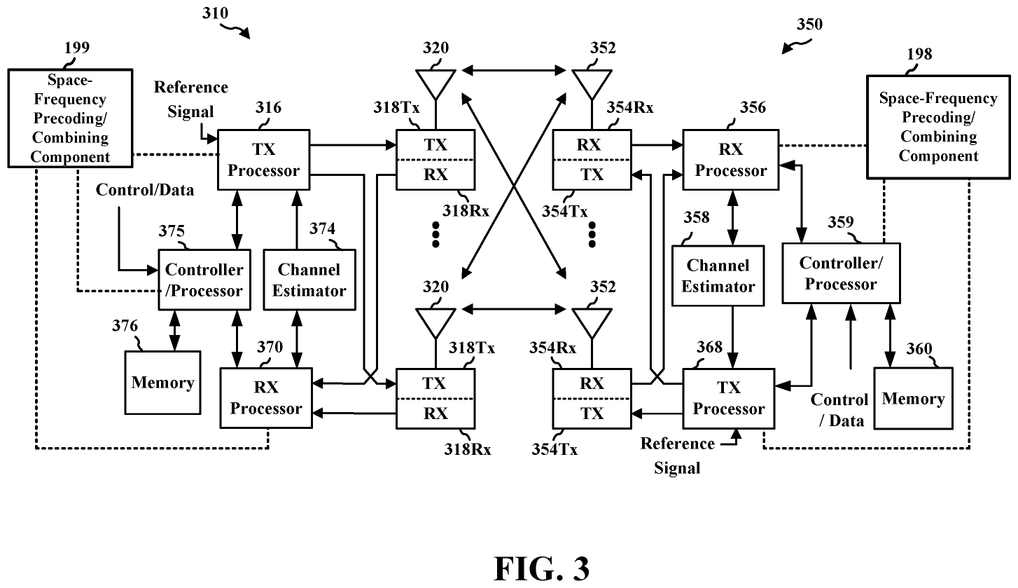

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the space-frequency precoding/combining component 198 of FIG. 1.

At least one of the TX processor 316, the RX processor 370, and the controller/processor 375 may be configured to perform aspects in connection with the space-frequency precoding/combining component 199 of FIG. 1.

Some wireless communication may be performed in a sub-terahertz (Sub-THz) frequency band. Among other examples, Sub-THz frequencies may be used for 6G wireless communication. The Sub-THz band has several characteristics specific thereto, which impose new limitations and challenges related to feasible and efficient massive Sub-THz deployment options. There are several challenges for massive Sub-THz deployment.

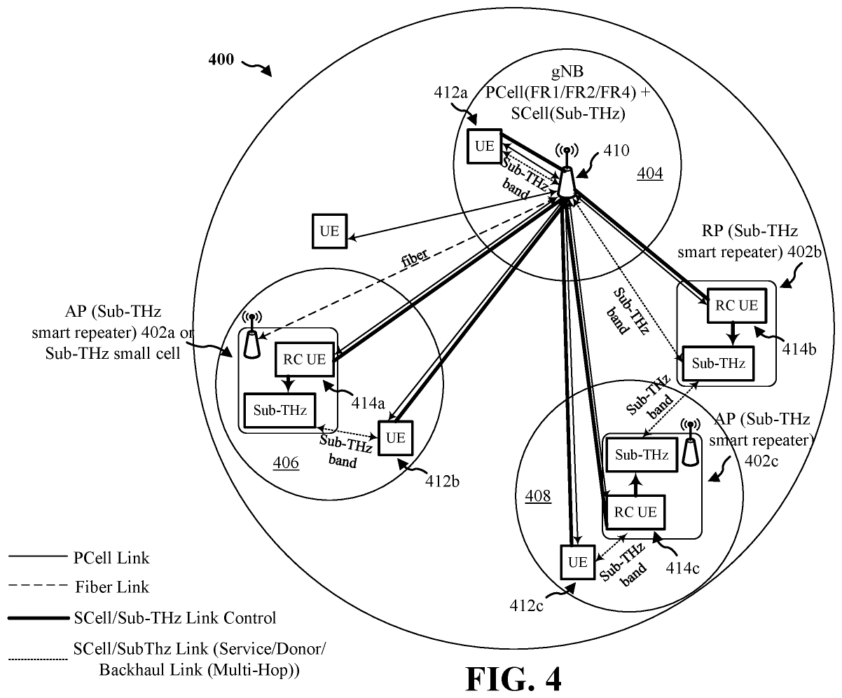

One challenge is higher limited maximum power amplifier (PA) output power characteristics (e.g., ˜10 decibels (dB) less compared to P As used for the mmW band) coupled to a much higher signal bandwidth, which results in an effective isotropic radiated power (EIRP) deficit for the Sub-THz link. Correspondingly, much more limited coverage can be achieved (˜2 to 3 times lower than for the mmW band). Another challenge is an at least factor two reduction in Sub-THz PA efficiency (e.g., compared to PAs used for the mmW band), thereby resulting in a very poor Sub-THz link power/energy efficiency. A further challenge relates to an anticipated higher power consumption for Sub-THz Rx/Tx operations in general, which is dictated by a much higher signal bandwidth (due to subcarrier spacing being at least 8 times higher) and extremely high targeted data rates. The extreme power consumption is contributed by less power-efficient RF processing, a much higher power consumption related to analog-to-digital (A2D)/digital-to-analog (D2A) components having increased sampling rates (roughly linearly-translated to the consumed power), higher rate digital processing, extremely high bit rates to be addressed on the decoder side, higher memory/storage (e.g., intermediate buffers), related power consumption, etc. In one aspect of the present disclosure, a deployment approach for Sub-THz bands is utilized to allow a massive and power efficient Sub-THz deployment for a variety of use cases and scenarios, which addresses the limitations and challenges described above. For example, FIG. 4 is a diagram 400 illustrating a deployment for Sub-THz bands. The illustrated deployment approach for power efficient Sub-THz deployment assumes a massive usage of lower power smart repeaters (RPs) 402a, 402b, and 402c to establish long range multi-hop links connecting multiple Sub-THz coverage spots 404, 406, and 408 distributed under PCell coverage areas (FR1/FR2) to a centralized Sub-THz network node 410 transceiver (e.g., a gNB transceiver) that serves the spot-based Sub-THz coverage that is addressed as a distributed SCell (under PCell coverage range).

The power efficient Sub-THz deployment illustrated in FIG. 4 may be implemented with a spot-based coverage within PCell range and may be based on various aspects. For example, the deployment may be based on inter-band carrier aggregation (CA), where Sub-THz is addressed as an SCell, and the PCell is based on a lower frequency band (e.g., FR1/FR2/FR4). The Sub-THz SCell may have a minimum scope of critical functionality (i.e., the SCell relies on a PCell/a lower frequency band cell as much as possible) and may not utilize “always on” signals (e.g., cell-specific reference signals (CRSs)). The SCell may be activated for sporadic and typically short time sessions and may have a burst activity pattern (similar to Wi-Fi-based signals). Such utilization of inter-band CA may also enable fast and low complexity, low power, low latency synchronization and beam management (BM) and/or recovery procedures per SCell activation. The SCell synchronization and beam management may be partially based on the PCell (e.g., a “warm start” for every Sub-THz link activation).

In another example, the deployment may be based on single or multi-hop repeating between UEs 412a, 412b, and 412c (supporting Sub-THz) and the Sub-THz network node 410 transceiver to bridge over Sub-THz range limitations. The power-efficient smart repeaters (RPs/APs) 402a, 402b, and 402c may utilize out-of-band (OOB) control based on the Pcell and may be used for Sub-THz. The smart Sub-THz repeaters 402a, 402b, and 402c may include various functional parts. For instance, the repeaters 402a, 402b, and 402c may include reduced capability (or RedCap) UEs 414a, 414b, and 414c respectively for PCell connectivity (e.g., to deliver OOB control/reports/feedback, etc.).

In some examples, a RedCap UE may have an uplink transmission power of at least 10 dB less than that a higher capability UE (e.g., premium smartphones, V2X devices, URLLC devices, eMBB devices, etc.). As another example, a RedCap UE may have reduced transmission bandwidth or reception bandwidth than other UEs. For instance, a RedCap UE may have an operating bandwidth between 5 MHz and 10 MHz for both transmission and reception, in contrast to other UEs which may have 20-100 MHz bandwidth. As a further example, a RedCap UE may have a reduced number of reception antennas in comparison to other UEs. For instance, a RedCap UE may have only a single receive antenna and may experience a lower equivalent receive signal to noise ratio (SNR) in comparison to higher capability UEs that may have multiple antennas. RedCap UEs may also have reduced computational complexity than other UEs. Examples of RedCap devices may include wearables, industrial wireless sensor networks (IWSN), surveillance cameras, low-end smartphones, etc. For example, NR communication systems may support both higher capability devices and reduced capability devices. A RedCap device may be referred to as an NR light device, a low-tier device, a lower tier device, etc. RedCap UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

The repeaters 402a, 402b, and 402c may also include wideband (WB) amplify and forward (AF) functionality for Sub-THz data forwarding. The repeaters 402a, 402b, and 402c may also include a dedicated narrowband (NB) local single sideband (SSB)/synchronization reference signal (RS) Tx/Rx capability over Sub-THz for complementary time synchronization and beam refinement. Such a deployment may also support progressive synchronization across hops, hop-specific synchronization, and beam management sessions with customizing synchronization RS/SSB mini-burst scheduling.

It is noted that the smart repeaters 402a, 402b, and 402c depicted in FIG. 4 may be either an AP or an RP. RPs may be utilized in situations where additional repeaters are utilized to obtain connectivity between an AP and the network node 410. An AP and an RP may conceptually have the same or similar functionality, but may have some hardware and capability differences. Different names for such devices may be utilized, for example, to subdivide different usage types (e.g., the term “access point” may be used for a repeater having a direct connection with UEs (i.e., a service link), and the term “repeater” may be used for a repeater having an intermediate or direct link with a network node (i.e., a donor link)).

It is also noted that certain criteria may be met in order for the UEs 412a, 412b, and 412c to communicate via a Sub-THz session. For instance, one criteria is that the UEs 412a, 412b, and 412c are in the coverage range of the Sub-THz repeater 402a, 402b, or 402c or the network node 410. Another criteria is that the mobility of the UEs 412a, 412b, and 412c is less than a defined threshold (e.g., semi-static Sub-THz beam and channel). A further criteria is that the UEs 412a, 412b, and 412c may have a capability enabling Sub-THz communication sessions. Another criteria is that the UEs 412a, 412b, and 412c have enough battery resource(s) (e.g., the UEs 412a, 412b, and 412c have a certain battery charge level that meets a defined threshold). A further criteria is that the UEs 412a, 412b, and 412c have a data volume requirement or potential that meets a defined threshold.

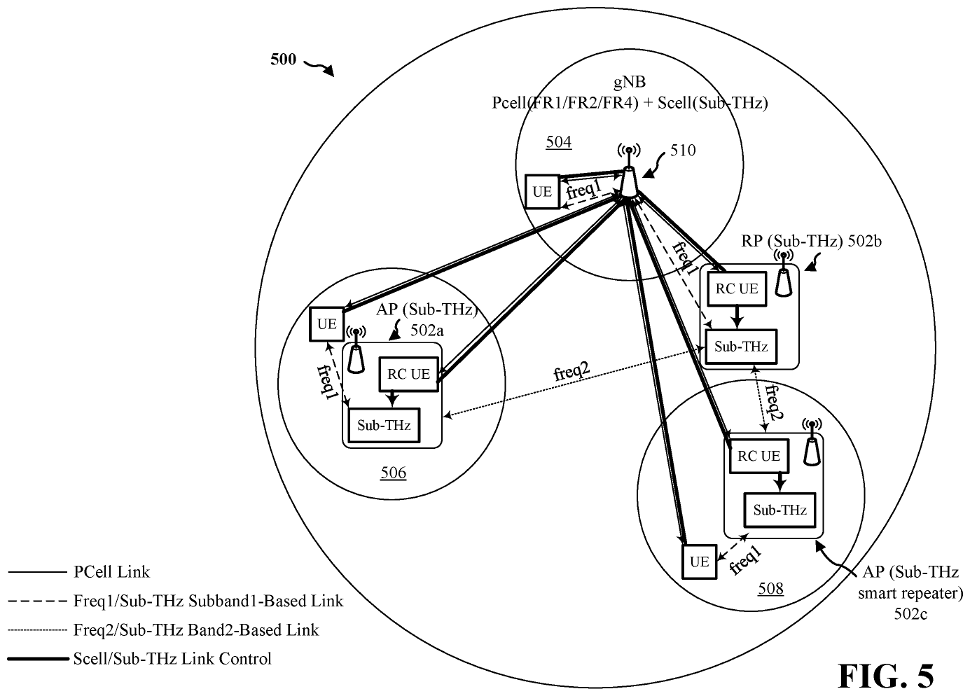

In order to allow an increased range for multi-hop links with an improved power efficiency and high UE access bandwidth, as supported by the Sub-THz band, hybrid frequency multi-hop links with LOS MIMO on certain intermediate hops/bands may be utilized. For example, FIG. 5 is a diagram 500 illustrating a deployment for Sub-THz bands that utilizes hybrid frequency multi-hop links with LOS MIMO. The deployment shown in FIG. 5 may be based on a combination of different bands/carrier frequencies employed across different hops of multi-hop links that utilize LOS MIMO on certain hops/bands to keep a balanced capacity on different hops/bands.

In the deployment shown in FIG. 5, fully analog processing (amplify and forward functionality) may be utilized on the smart repeater side (RP/AP) for an improved power efficiency. Utilizing digital signal processing/regeneration on the repeater side in situations of very high Sub-THz signal bandwidth/throughput may disadvantageously cause higher power consumption. That is, smart repeaters 502a, 502b, and 502c may utilize fully analog processing rather than digital signal processing.

However, fully analog repeaters may experience Tx-to-Rx leakage, e.g., in which a transmission by the repeater is received as interference by the repeater, which limits the maximum transmission power of such repeaters and the corresponding maximum hop/link range (AP/RP range) and Sub-THz spot size (AP range). That is, the Tx-to-Rx leakage may limit the maximum transmission power of repeaters (e.g., the smart repeaters 502a and 502c), and therefore, limit the corresponding maximum hop/link range of the repeaters, as well as the coverage area (e.g., coverage spots or areas 506 and 508) of the repeaters.

To mitigate (at least partially) the above-described issues, different carrier frequencies may be used on different sides (Tx and Rx) of analog repeaters (e.g., the smart repeaters 502a, 502b, and 502c) to increase Tx-to-Rx isolation based on frequency domain separation. Frequency domain-based separation of Tx and Rx signals on the repeater side allows nonstable/resonating power loops to be avoided such that any existing Tx/Rx leakage/isolation is addressed to avoid Rx-side low noise amplifier (LNA) saturation. The LNA saturation problem may be mitigated using a bandpass filter (BPF) before the LNA where frequency domain-based separation is significant (the utilized Tx and Rx side carrier frequencies may be well-separated, thereby allowing a significant BPF-based rejection of the leaking Tx signal).

An example of Sub-THz multi-hop links utilizing different carrier frequencies (freq1 and freq2) on different link hops is shown in FIG. 5. Usage of different well-separated carrier frequencies may allow higher range hops to be maintained (e.g., in situations where a FR1-based primary cell (PCell) 504 is deployed as an SCell with a spot-based coverage under the PCell coverage range, as shown in FIG. 5). To obtain an acceptable separation between Tx and Rx signals in the frequency domain, freq1 and freq2 may refer to different bands/subbands. Correspondingly, frequency band transitions between different hops of the multi-hop links may be employed to keep a power-efficient deployment. Different band combinations may be utilized for multi-hop Sub-THz links (e.g., a Sub-THz+Sub-THz combination, a Sub-THz+mmW combination).

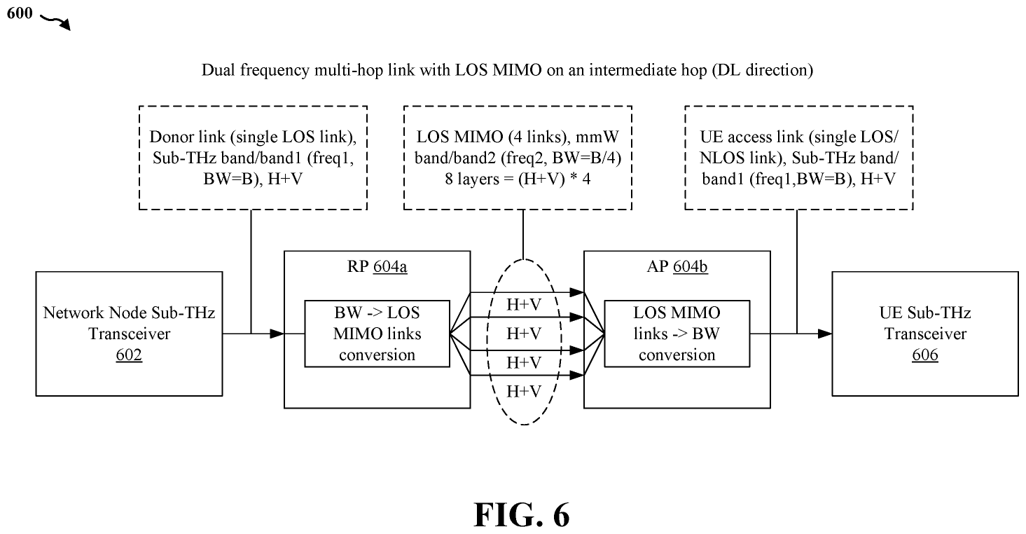

Some bands/scenarios may not provide a bandwidth that is comparable with the maximum bandwidth available on the Sub-THz band (˜7.5 GHz) that can be used for the direct access of a Sub-THz eligible UE. In order to keep a balanced capacity on different hops of a multi-hop link, intermediate hops using limited bandwidth or bandwidth-limited bands may employ LOS MIMO with multiple layers to compensate for any hop-specific bandwidth limitations (to allow a balanced capacity across hops). In one example, two bands/subbands (freq1 and freq2) with the same available bandwidth (B) may be utilized. This may be a constraint when targeting a very high UE access bandwidth over Sub-THz because this option may require a very high bandwidth utilization per link (2×B). LOS MIMO may not be involved in this case on any hop. In another example, band1 may have a first bandwidth (BW1) and a signal spatial link (with a horizontal (H) polarization) and a vertical (V) polarization), while band2 may have a second bandwidth (BW2) that is equal to, for example, 0.25×BW1. However, this example may utilize LOS MIMO with 4 spatial links (each one with an H and V polarization), such that a balanced link capacity is maintained across all the hops through a space-frequency capacity balancing/combination. The corresponding multi-hop link architecture example is shown in FIG. 6.

For example, FIG. 6 is a diagram 600 that depicts an example hybrid frequency multi-hop link architecture. As shown in FIG. 6, the architecture may comprise a network node (e.g., gNB) 602 including a Sub-THz transceiver, smart repeaters 604a and 604b, and a UE 606 including a Sub-THz transceiver. To perform the frequency transformations from one band to the other band, the overall multi-hop link capacity may be maintained across all its hops (and corresponding resources). For example, the first hop/repeater Rx side capacity (with its overall resources) may be equal to the second hop/repeater Tx side capacity (overall throughput in bandwidth size, number of layers, etc.).

The diagram 600 of FIG. 6 represents an example of a downlink multi-hop link over different frequency bands (e.g., Sub-THz and mmW bands) that involve LOS MIMO over the mmW band with multiple layers in order to maintain the same overall hop capacity over the mmW band as for the Sub-THz band. It is noted that while the diagram 600 illustrates an architecture with respect to a downlink multi-hop link, the architecture may also be applicable to an uplink multi-hop link.

In accordance with the diagram 600 of FIG. 6, the donor link and the UE access link may utilize a first band (band1) (e.g., a Sub-THz band with large bandwidth and a single link having two polarizations (H+V)). The intermediate link (the smart repeater 604a to smart repeater 604b link) may utilize a second band (band2) (e.g., a link over the mmW band (FR2/FR4) with a smaller bandwidth, but with an increased number of corresponding links (LOS MIMO)).

The intermediate link may include 4 spatial link mmW links (LOS MIMO), each one with 2 layers (8 layers over H and V polarizations overall). Each link may be based on a dedicated lens beamformer (4 dual polarization lens beamformers may be used on each hop side for the MIMO-based hop). Utilizing lens beamformers may allow digital beam refinement/selection per link (for reduced interlink interference) as a part of an installation procedure and/or per-Sub-THz link activation procedure (which would not be implementable using a parabolic antenna, for example, or any fixed beam solution). A lens beamformer may also have a much lower power consumption compared to array-based beamformers, which allows a more flexible beamforming from one side, but with a much higher power consumption from the other side.

With a 1.875 Ghz mmW link bandwidth and 4 spatial links (8 H+V layers), it is possible to effectively obtain 100% of the maximum Sub-THz band bandwidth (7.5 GHz). Equivalently, in a generic form, similar to the example provided in FIG. 6, with the assumed parametrization of the hybrid frequency multi-hop link and 8×8 LOS MIMO on the mmW band (where a direct UE access of BW=B over Sub-THz is targeted), the overall occupied bandwidth for the Sub-THz-based traffic offloading (including all its hops) may be B+B/4 (instead of 2B, as in the case that LOS MIMO is not used). Instead, two frequencies (freq1 and freq2) that are based on two different Sub-THz bands/subbands (with BW=B on each one of them) would be utilized.

In accordance with the architecture illustrated in the diagram 600 of FIG. 6, a better power efficiency is expected compared to an option where only a Sub-THz band is used because an mmW-based power amplifier is more power efficient (e.g., about 2 times more power efficient) than a Sub-THz power amplifier (e.g., the power of a Sub-THz power amplifier with a BW equal to B is translated to 4 times the power of a mmW power amplifier with a BW of B/4).

Aspects of the present disclosure address aspects related to dealing with different frequency bands/subbands combination(s) and related LOS MIMO component(s) involved in the multi-hop scheme such that MIMO-related Tx precoding and Rx combining procedures are transparent for the smart repeaters and such that analog processing (rather than digital processing) on the repeater side is maintained. In particular, aspects of the present disclosure are directed to space-frequency precoding techniques that address hybrid multi-hop links in a transparent end-to-end (E2E) manner (as if a single hop-equivalent MIMO scheme were utilized) without any digital processing on the repeater side coupled to a LOS MIMO hop. In some aspects of the present disclosure, a wireless device (e.g., a network node or a UE) is configured to precode data based on a space-frequency precoding scheme across a plurality of spatial ports and virtual ports based on frequency over which the data is to be transmitted and to transmit, to a repeater, the space-frequency precoded data via the plurality of spatial ports and layers associated with the virtual ports. The wireless device may also be configured to receive a signal from a repeater comprising data precoded based on a space-frequency precoding scheme across a plurality of spatial ports and virtual ports and to derive. separate virtual data streams by applying space-frequency minimum mean square error (MMSE) combining of the received signal across multiple reception ports. In certain aspects of the present disclosure, a repeater is configured to receive, over a first frequency bandwidth, a signal from a first wireless device, the signal comprising data precoding based on a space-frequency precoding scheme across a plurality of spatial ports and virtual ports and to forward, without decoding, the signal to a second wireless device over a second frequency bandwidth as a line-of-sight (LOS) multiple-input and multiple-output (MIMO) signal. In certain aspects of the present disclosure, an access point is configured to receive, from a repeater, a signal comprising data precoded based on a space-frequency precoding scheme across a plurality of spatial ports and virtual ports, the signal received as an LOS MIMO over a second frequency bandwidth, to recompose the signal to the first frequency bandwidth, and to transmit the signal to the UE over the first frequency bandwidth.

The space-frequency precoding techniques described herein may be implemented utilizing the employment of LOS MIMO over an mmW link/band on an intermediate hop of a Sub-THz multi-hop link in accordance with the architecture described above with reference to FIG. 6. LOS MIMO may involve some level of interstream leakages that can be reduced with a proper precoding on the Tx side and MMSE combining on the Rx side applied on the relevant hop. Precoding/MMSE combining on the repeater side may require digital processing, which is avoided utilizing the techniques described herein. Thus, the techniques described herein advantageously achieve a more power-efficient long-range Sub-THz link/wide range spot-based Sub-THz/SCell deployment and coverage. To preserve analog processing for Sub-THz link-related repeaters (even with an mmW frequency-based intermediate hop with LOS MIMO, the space-frequency precoding techniques described herein address the hybrid multi-hop link as an equivalent single hop MIMO link over Sub-THz (from the UE (supporting sub-THz)/network node (e.g., gNB) perspective) that can be addressed for E2E transmission procedures, including precoding for a LOS MIMO hop applied at the E2E transmitter side and MMSE space-frequency combining procedures applied on the E2E receive side. In other words, the transmission scheme described herein may convert a hybrid frequency multi-hop link with LOS MIMO on an intermediate hop into an equivalent single hop multilayered MIMO over Sub-THz (i.e., a “transparent” E2E MIMO channel).

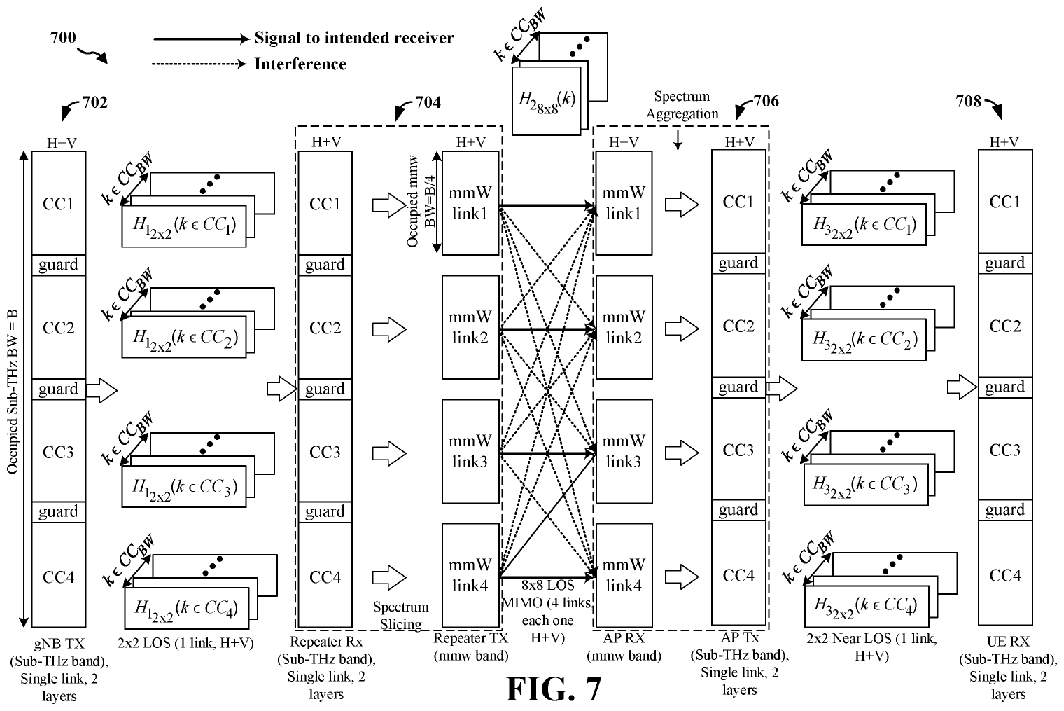

FIG. 7 is a diagram 700 illustrating a hybrid band multi-hop link with LOS MIMO in accordance with various aspects of the present disclosure. As shown in FIG. 7, the hybrid band multi-hop link includes a network node 702, a repeater 704, an access point (or repeater) 706, and a UE 708. The network node 702 may be configured to transmit data via a first frequency band (e.g., band1), such as a Sub-THz band or Sub-THz subband. The band1 transmission may include 2 spatial ports (H+V) and 4 virtual/frequency Tx ports over the entire band1 bandwidth. The network node 702 may decompose the frequency dimension into virtual channels (also referred herein as component carriers (“CCs”), subchannels, or bandwidth parts), where each CC bandwidth chunk (4 chunks, which may be referred to as frequency segments, in the example shown in FIG. 7) represents a corresponding virtual port and the associated pair of H and V ports. In the example shown in FIG. 7, there are 8 overall Tx ports: 2 (H/V)×4 chunks. The first chunk or component carrier represents virtual Tx ports 1 and 2, the second chunk or component carrier represents virtual Tx ports 3 and 4, the third chunk or component carrier represents virtual Tx ports 5 and 6, and the fourth chunk or component carrier represents virtual Tx ports 7 and 8. As further shown in FIG. 7, a guard band may be between each of the subchannels to support analog bandwidth slicing operations on the repeater side (e.g., slicing performed by the repeater 704) and to prevent leakage between the subchannels.

The network node 702 may also decompose the input data into 8 virtual streams/layers correspondingly and apply space-frequency precoding for 8 virtual data streams across all the Tx ports (after virtual port expansion). The network node 702 may transmit the space-frequency precoded virtual data streams to the repeater 704.

The repeater 704 may be configured to receive the data streams from the network node 702 via the first frequency band (e.g., band1). The repeater 704 may be configured to separate/slice the entire band1 allocation BW (B) into 4 chunks/channels having a smaller bandwidth (e.g., bandwidth/4). For example, the repeater 704 may perform spectrum slicing on the entire band1 allocation to obtain the smaller chunks/channel having the smaller bandwidth. In the example shown in FIG. 7, the repeater 704 may apply the 4 chunks/channels to LOS MIMO transmitters (dual polarization transmitter per channel) with overall 4 spatial links/transmitters (total 4 LOS MIMO links, each one with 2 polarizations (H+V), thereby enabling 8×8 LOS MIMO). That is, the repeater 704 applies each of the 4 chunks/channels to a corresponding LOS MIMO transmitter. Thus, the number of chunks/channels (e.g., frequency segments) corresponds to the number of MIMO streams of the repeater 704. The LOS MIMO transmitters of the repeater 704 may transmit the data streams via a second frequency band (e.g., a different Sub-THz subband or a mmW band). In the example shown in FIG. 7, the second frequency band is an mmW band. The over-the-air channel may combine all the links/layers, thereby introducing some cross layer-interference on the receiving side of the LOS MIMO link (e.g., the repeater 706) due to a non-perfect LOS MIMO geometry/link separation. For example, as shown in FIG. 7, a first mmW link (mmW link1) of the repeater 706 receives the intended data from a first mmW link (mmW link1) of the repeater 704, as well as interfering data from a second mmW link (mmW link2) of the repeater 704, a third mmW link (mmW link3) of the repeater 704, and a fourth mmW link (mmW link4) of the repeater 704. A second mmW link (mmW link2) of the repeater 706 receives the intended data from the second mmW link (mmW link2) of the repeater 704, as well as interfering data from the first mmW link (mmW link1) of the repeater 704, the third mmW link (mmW link3) of the repeater 704, and the fourth mmW link (mmW link4) of the repeater 704. A third mmW link (mmW link3) of the repeater 706 receives the intended data from the third mmW link (mmW link3) of the repeater 704, as well as interfering data from the first mmW link (mmW link1) of the repeater 704, the second mmW link (mmW link2) of the repeater 704, and the fourth mmW link (mmW link4) of the repeater 704. A fourth mmW link (mmW link4) of the repeater 706 receives the intended data from the fourth mmW link (mmW link4) of the repeater 704, as well as interfering data from the first mmW link (mmW link1) of the repeater 704, the second mmW link (mmW link2) of the repeater 704, and the third mmW link (mmW link3) of the repeater 704.

The repeater 706 may take each LOS MIMO receiver output (e.g., 4 dual polarization receivers, as shown in FIG. 7) comprising H and V polarizations on the corresponding bandwidth part/CC/channel and may allocate the receiver output back (H+V) into the corresponding frequency domain location on the band1 bandwidth (e.g., re-span back the frequency domain over band1), for example, via spectrum aggregation. The repeater 706 may transmit the recomposed band1 bandwidth (H+V) to the UE 708. That is, the repeater 706 may transmit the data to the UE 708 via the first frequency band.

The UE 708 may receive the entire band1 (e.g., a Sub-THz band or subband) bandwidth (B), may sub-divide the received bandwidth into CCs/channels representing virtual Rx antennas, and may apply space-frequency MMSE combining across all the Rx antennas after virtual expansion. For instance, the UE 708 may decompose the band1 frequency dimension in virtual channels/CCs, where each CC bandwidth chunk represents a corresponding virtual Rx antenna and the associated pair of H and V Rx antennas/receptions (in the example shown in FIG. 7, there is a total of 8 Rx antennas after virtual expansion (4 virtual Rx ports*2 (H+V Rx ports)). The UE 708 may implement MMSE combining across all the Rx ports (after the virtual Rx antennas expansion) in order to derive separated virtual data streams (e.g., 8 streams) and remove the cross-layer interferences in the overall link (as described above with respect to the mmW links of the repeaters 704 and 706).

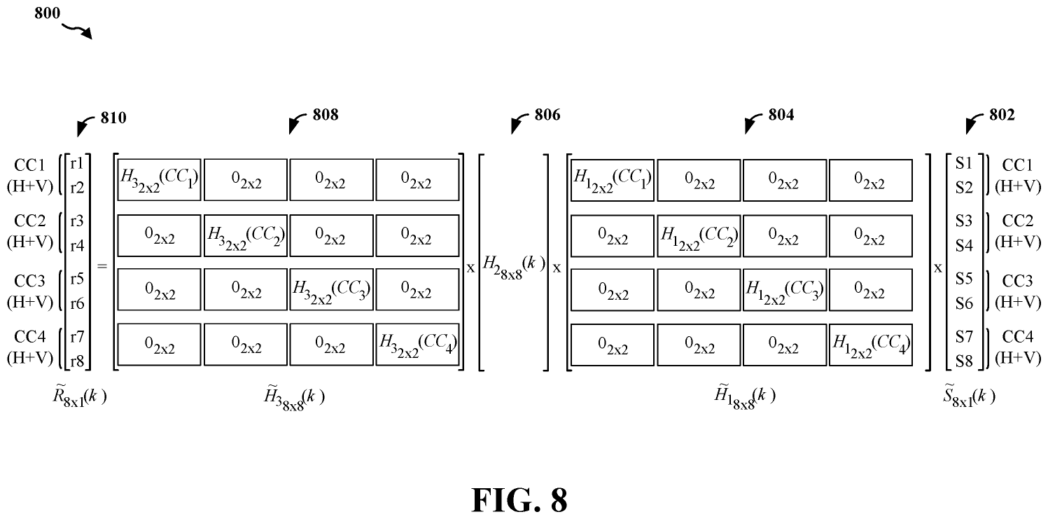

FIG. 8 is a diagram 800 that illustrates a representation of a signal transmitted by the network node 702 and received by the UE 708 shown in FIG. 7. For example, as shown in FIG. 8, a matrix represents a signal § 8×1 (k) 802 transmitted by the network node 702 to the repeater 704. S1 corresponds to the H polarization and S2 corresponds to the V polarization of the first CC chunk (CC1) (e.g., a frequency segment), S3 corresponds to the H polarization and S4 corresponds to the V polarization of the second CC chunk (CC2), S5 corresponds to the H polarization and S6 corresponds to the V polarization of the third CC chunk (CC3), and S7 corresponds to the H polarization and S8 corresponds to the V polarization of the fourth CC chunk (CC4). The matrix 804 represents the direct channel \tilde{H}₁_{_{8×8}} (k) by which the signal is transmitted to the repeater 704. The matrix 806 represents the channel H₂_{_{8×8}} (k) by which the repeater 704 transmits the signal to the repeater 706. The channel H₂_{_{8×8}} (k) represents a combination of the entire signal (including the cross-interference) that is transmitted by the repeater 704 and received by the repeater 706. The matrix 808 represents the direct channel \tilde{H}₃_{_{8×8}} (k) by which the signal is transmitted by the repeater 706 to the UE 708. The matrix 810 represents a signal \tilde{R}_{8×1}(k) 802 received by the UE 708 from the repeater 706. r1 corresponds to the H polarization and r2 corresponds to the V polarization of the first CC chunk (CC1), r3 corresponds to the H polarization and r4 corresponds to the V polarization of the second CC chunk (CC2), r5 corresponds to the H polarization and r6 corresponds to the V polarization of the third CC chunk (CC3), and r7 corresponds to the H polarization and r8 corresponds to the V polarization of the fourth CC chunk (CC4).

The hybrid band multi-hop link with LOS MIMO described above with reference to FIGS. 7 and 8 may be modeled in accordance with Equation 1, which is provided below:

$$\begin{matrix}{\tilde{R}}_{8 \times 1} ( k ) = {\tilde{H}}_{{3}_{8 \times 8}} ( k ) \cdot {H}_{{2}_{8 \times 8}} ( k ) \cdot {\tilde{H}}_{{1}_{8 \times 8}} ( k ) \cdot {\tilde{S}}_{8 \times 1} ( k ) \\ {=}^{△} {H}_{{eff}_{8 \times 8}} ( k ) \cdot {\tilde{S}}_{8 \times 1} ( k ) \\ = U ( k ) Λ ( k ) {V}^{H} ( k ) \cdot {\tilde{S}}_{8 \times 1} ( k )\end{matrix} \qquad Eq . 1$$

In accordance with Equation 1, \tilde{H}₃_{_{8×8}} (k), H₂_{_{8×8}} (k), and \tilde{H}₁_{_{8×8}} (k) may be combined to represent the effective channel H_{eff}_{_{8×8}} (k). A singular value decomposition (SVD) operation may be performed on the effective channel H_{eff}_{_{8×8}}(k) to obtain the three matrices U(k), Λ(k), and V^{H}(k).

Referring again to FIG. 7, adding transmit precoding and MMSE combining to the system based on the above model of Equation 1, the transmit side of the network node 702 may perform a precoding operation P_{8×8}(k) that combines all the Tx ports (after introducing virtual ports, as shown in FIG. 7) per frequency index k (that are then transmitted through the E2E multi-hop link). The Rx side of the UE 708 Rx may perform MMSE combining W_{MMSE}_{_{8×8}}(k) across all Rx ports/antennas (after introducing virtual antennas, as shown in FIG. 7) in order to derive separated virtual data streams and remove the cross-layer interferences between the repeaters 704 and 706 in the overall link. The transmit precoding and the MMSE combining may be modeled in accordance with Equation 2, which is provided below:

Ŝ_{8×1}(k)=W_{MMSE}_{_{8×8}}(k)·U(k)Λ(k)V^{H}(k)·P_{8×8}(k)·\tilde{S}_{8×1}(k) Eq. 2

where Ŝ_{8×1}(k) represents the reconstructed signal at the UE 708.

The techniques described above with the provided modeling may utilize space-frequency (over H, V and virtual Tx ports) precoding on the Tx side (e.g., of the UE 708 and the network node 702) and space-frequency MMSE combining (over H, V and virtual Rx ports) on the Rx side (e.g., of the network node 702 and the UE 708).

After modeling the full end-to-end channel link as H_{eff} for an 8×8 effective E2E MIMO system, all intermediate per-hop channels may be transparent. With the E2E effective MIMO channel modeling described above, E2E Tx side precoding (space-frequency) and E2E Rx side MMSE combining (space-frequency) are utilized without requiring precoding and combining in any of the intermediate hops. Correspondingly, for intermediate hops/smart repeaters, analog processing (e.g., little to no digital processing) may be utilized in the context of Sub-THz power efficient deployment (relatively high power consuming digital processing for extremely high bandwidth/throughput Sub-THz signals on the intermediate hops may be avoided). The provided transparent E2E modeling may utilize virtual data layers from the E2E Tx and Rx edge perspective (e.g., virtual Tx ports and virtual Rx antennas mapped to different band1 bandwidth parts/CCs/channels (according to the overall number of LOS MIMO layers on the intermediate hop)). Space-frequency precoding may be applied on the Tx side across all the Tx antenna ports (after the addition of virtual Tx ports) and space frequency MMSE combining on the Rx side may be applied across all the Rx antennas (after the addition of virtual Rx antennas). Input data may be mapped on all the data layers/streams (after virtual layers addition/expansion), and each data layer may be associated/mapped to one of the bandwidth parts/CCs/channels and one of the H or V polarizations corresponding to the bandwidth parts/CCs/channels (8 data streams/virtual layers overall in the example shown in FIG. 7). The number of modulated symbols per data stream may be determined based on the bandwidth part/CC/channel size (which is determined based on the utilized intermediate hop bandwidth on top of which LOS MIMO is utilized).

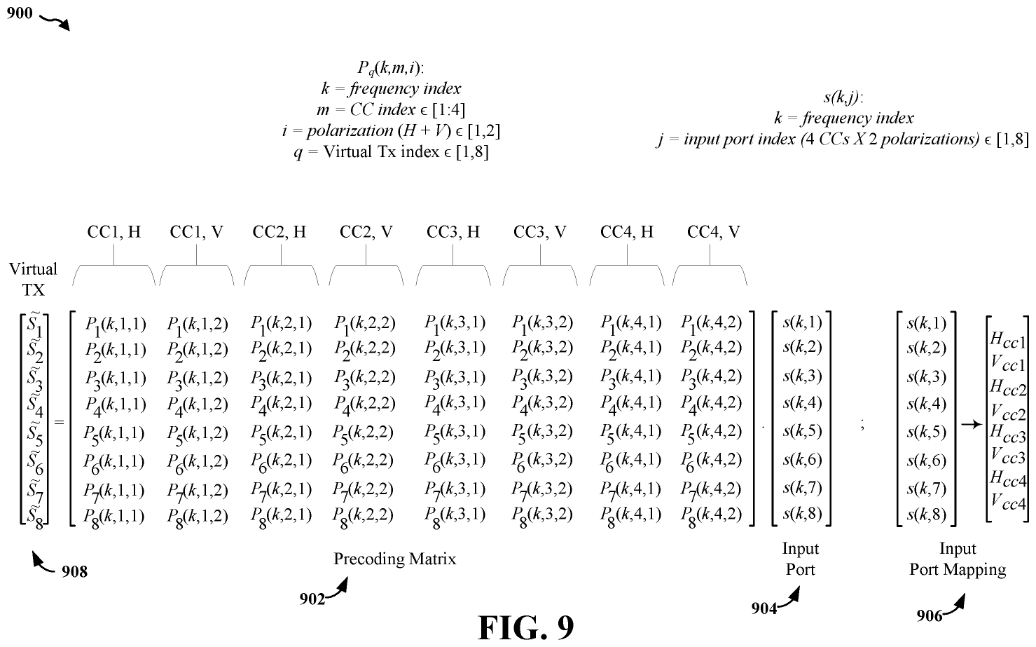

FIG. 9 is a diagram 900 illustrating a precoding matrix 902 utilized for space-frequency precoding performed by a transmitting device. The precoding matrix 902 may represent P_{8×8}(k), as described above with reference to Equation 2. In an aspect, as shown in FIG. 9, space-frequency precoding by a transmitting device (e.g., the network node 702 for downlink transmissions or the UE 708 for uplink transmissions) may be performed per subcarrier (or frequency index k) over the entire bandwidth. In another aspect, the transmitting device may utilize the same precoder to perform space-frequency precoding for several consecutive subcarriers. In a further aspect, the transmitting device may utilize a wideband precoder to perform space-frequency precoding for a plurality of (e.g., all) the subcarriers. For example, the precoding matrix 902 may be applied to input ports 904 of the transmitting device. In the example shown in FIG. 9, the precoding matrix 902 is applied to 8 input ports 904, where each of the 8 input ports 904 is mapped to a particular polarization of a component carrier in accordance with an input port mapping 906. For instance, a first input port (e.g., s(k,1)) for a particular frequency index k may be mapped to a first polarization (e.g., an H polarization) for a first component carrier (e.g., CC1). A second input port (e.g., s(k,2)) for a particular frequency index k may be mapped to a second polarization (e.g., a V polarization) for the first component carrier (e.g., CC1). A third input port (e.g., s(k,3)) for a particular frequency index k may be mapped to a first polarization (e.g., an H polarization) for a second component carrier (e.g., CC2). A fourth input port (e.g., s(k,4)) for a particular frequency index k may be mapped to a second polarization (e.g., a V polarization) for the second component carrier (e.g., CC2). A fifth input port (e.g., s(k,5)) for a particular frequency index k may be mapped to a first polarization (e.g., an H polarization) for a third component carrier (e.g., CC3). A sixth input port (e.g., s(k,6)) for a particular frequency index k may be mapped to a second polarization (e.g., a V polarization) for the third component carrier (e.g., CC2). A seventh input port (e.g., s(k,7)) for a particular frequency index k may be mapped to a first polarization (e.g., an H polarization) for a fourth component carrier (e.g., CC4). An eighth input port (e.g., s(k,8)) for a particular frequency index k may be mapped to a second polarization (e.g., a V polarization) for the fourth component carrier (e.g., CC4).

The first column of the precoding matrix 902 represents coefficients for a particular frequency index k that are associated with a first component carrier (e.g., CC1) having a first polarization (e.g., H). The second column of the precoding matrix 902 represents coefficients for a particular frequency index k that are associated with the first component carrier (e.g., CC1) having a second polarization (e.g., V). The third column of the precoding matrix 902 represents coefficients for a particular frequency index k that are associated with a second component carrier (e.g., CC2) having a first polarization (e.g., H). The fourth column of the precoding matrix 902 represents coefficients for a particular frequency index k that are associated with the second component carrier (e.g., CC2) having a second polarization (e.g., V). The fifth column of the precoding matrix 902 represents coefficients for a particular frequency index k that are associated with a third component carrier (e.g., CC3) having a first polarization (e.g., H). The sixth column of the precoding matrix 902 represents coefficients for a particular frequency index k that are associated with the third component carrier (e.g., CC3) having a second polarization (e.g., V). The seventh column of the precoding matrix 902 represents coefficients for a particular frequency index k that are associated with a fourth component carrier (e.g., CC4) having a first polarization (e.g., H). The eighth column of the precoding matrix 902 represents coefficients for a particular frequency index k that are associated with the fourth component carrier (e.g., CC4) having a second polarization (e.g., V). It is noted that P_{q} varies over different frequency indices k.

As further shown in FIG. 9, a virtual Tx port representation 908 based on the precoding matrix 902 illustrates data S transmitted after precoding (e.g., after the precoding matrix 902 is applied to the data s of the input port 904). As shown in FIG. 9, \tilde{S}₁ represents the data associated with a first component carrier (CC1) having a first polarization (e.g., H), \tilde{S}₂ represents the data associated with the first component carrier (CC1) having a second polarization (e.g., V), \tilde{S}₃ represents the data associated with a second component carrier (CC2) having a first polarization (e.g., H), \tilde{S}₄ represents the data associated with the second component carrier (CC2) having a second polarization (e.g., V), \tilde{S}₅ represents the data associated with a third component carrier (CC3) having a first polarization (e.g., H), \tilde{S}₆ represents the data associated with the third component carrier (CC3) having a second polarization (e.g., V), \tilde{S}₇ represents the data associated with a fourth component carrier (CC4) having a first polarization (e.g., H), and Sg represents the data associated with the fourth component carrier (CC4) having a second polarization (e.g., V). Referring to FIG. 7, \tilde{S}₁ and \tilde{S}₂ may represent the data transmitted by the repeater 704 via mmW link1, \tilde{S}₃ and \tilde{S}₄ may represent the data transmitted by the repeater 704 via mmW link2, \tilde{S}₅ and \tilde{S}₆ may represent the data transmitted by the repeater 704 via mmW link3, and \tilde{S}₇ and \tilde{S}₈ may represent the data transmitted by the repeater 704 via mmW link4.

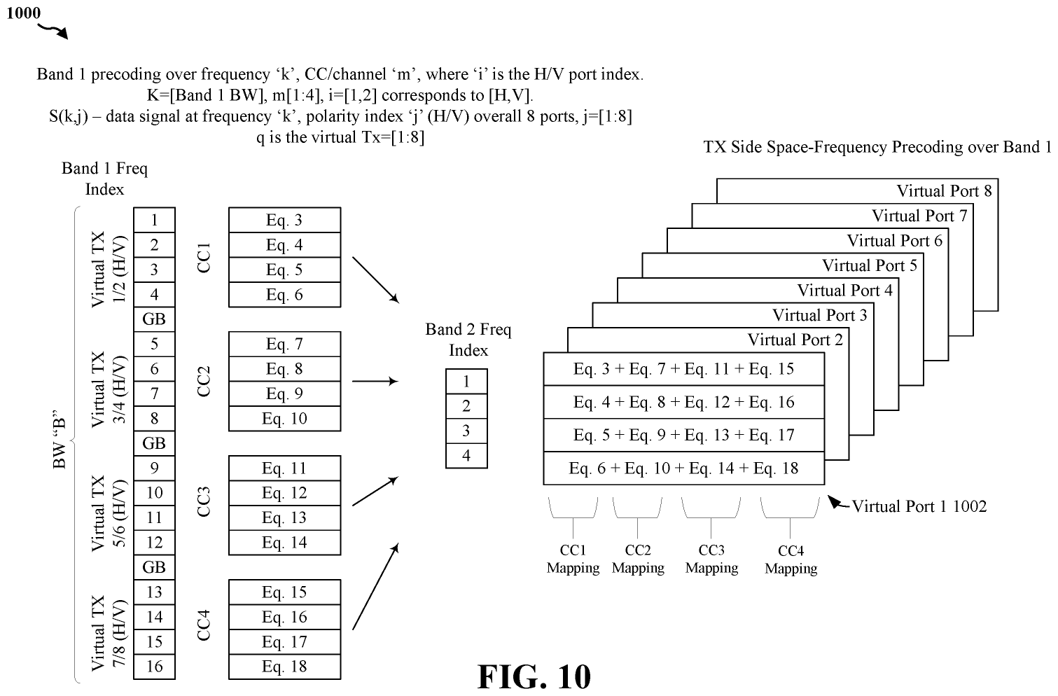

FIG. 10 is a diagram 1000 illustrating the precoding performed for a particular virtual port. In particular, FIG. 10 demonstrates the multiplication of the first row of the precoding matrix 902 and the data of the input port 904. As shown in FIG. 10, the entire bandwidth at the transmitter side (corresponding to band1 frequency indexes 1-16) is decomposed into different component carriers (CC1-CC4). Thereafter, precoding is performed for each of the frequency indexes. The precoding is performed in accordance with Equations 3 to 18, which are provided below. Equation 3 corresponds to the precoding performed for s(k,1) and s(k,2), where the frequency index k for CC1 is equal to 1, Equation 4 corresponds to the precoding performed for s(k,1) and s(k,2), where the frequency index k for CC1 is equal to 2, Equation 5 corresponds to the precoding performed for s(k,1) and s(k,2), where the frequency index k for CC1 is equal to 3, Equation 6 corresponds to the precoding performed for s(k,1) and s(k,2), where the frequency index k for CC1 is equal to 4, Equation 7 corresponds to the precoding performed for s(k,3) and s(k,4), where the frequency index k for CC2 is equal to 1, Equation 8 corresponds to the precoding performed for s(k,3) and s(k,4), where the frequency index k for CC2 is equal to 2, Equation 9 corresponds to the precoding performed for s(k,3) and s(k,4), where the frequency index k for CC2 is equal to 3, Equation 10 corresponds to the precoding performed for s(k,3) and s(k,4), where the frequency index k for CC2 is equal to 4, Equation 11 corresponds to the precoding performed for s(k,5) and s(k,6), where the frequency index k for CC3 is equal to 1, Equation 12 corresponds to the precoding performed for s(k,5) and s(k,6), where the frequency index k for CC3 is equal to 2, Equation 13 corresponds to the precoding performed for s(k,5) and s(k,6), where the frequency index k for CC3 is equal to 3, Equation 14 corresponds to the precoding performed for s(k,5) and s(k,6), where the frequency index k for CC3 is equal to 4, Equation 15 corresponds to the precoding performed for s(k,7) and s(k,8), where the frequency index k for CC4 is equal to 1, Equation 16 corresponds to the precoding performed for s(k,7) and s(k,8), where the frequency index k for CC4 is equal to 2, Equation 17 corresponds to the precoding performed for s(k,7) and s(k,8), where the frequency index k for CC4 is equal to 3, and Equation 18 corresponds to the precoding performed for s(k,7) and s(k,8), where the frequency index k for CC4 is equal to 4.

P₁(1,1,1)*S(1,1)+P₁(1,1,2)*S(1,2) (Eq. 3)

P₁(2,1,1)*S(2,1)+P₁(2,1,2)*S(2,2) (Eq. 4)

P₁(3,1,1)*S(3,1)+P₁(3,1,2)*S(3,2) (Eq. 5)

P₁(4,1,1)*S(4,1)+P₁(4,1,2)*S(4,2) (Eq. 6)

P₁(1,2,1)*S(1,3)+P₁(1,2,2)*S(1,4) (Eq. 7)

P₁(2,2,1)*S(2,3)+P₁(2,2,2)*S(2,4) (Eq. 8)

P₁(3,2,1)*S(3,3)+P₁(3,2,2)*S(3,4) (Eq. 9)

P₁(4,2,1)*S(4,3)+P₁(4,2,2)*S(4,4) (Eq. 10)

P₁(1,3,1)*S(1,5)+P₁(1,3,2)*S(1,6) (Eq. 11)

P₁(2,3,1)*S(2,5)+P₁(2,3,2)*S(2,6) (Eq. 12)

P₁(3,3,1)*S(3,5)+P₁(3,3,2)*S(3,6) (Eq. 13)

P₁(4,3,1)*S(4,5)+P₁(4,3,2)*S(4,6) (Eq. 14)

P₁(1,4,1)*S(1,7)+P₁(1,4,2)*S(1,8) (Eq. 15)

P₁(2,4,1)*S(2,7)+P₁(2,4,2)*S(2,8) (Eq. 16)

P₁(3,4,1)*S(3,7)+P₁(3,4,2)*S(3,8) (Eq. 17)

P₁(4,4,1)*S(4,7)+P₁(4,4,2)*S(4,8) (Eq. 18)

After the transmitting device performs the space-frequency precoding, the transmitting device provides the space-frequency precoding data to a repeater (e.g., the repeater 704), where the data from the entire bandwidth of a first frequency band (e.g., band1) (e.g., comprising 16 subcarriers) is converted into a second frequency band (e.g., band2) (e.g., comprising 4 subcarriers). As shown in FIG. 10, virtual port 1 1002 represents the data \tilde{S}₁ of the virtual Tx port representation 908 shown in FIG. 9. The other virtual ports are precoded in a similar manner according to a different Pq, where q corresponds to a virtual Tx index.

As described above, frequency conversions from a first frequency band (e.g., band1) to a second frequency band (e.g., band2) may be performed with a reduced bandwidth of the second frequency band that is compensated via an increased number of spatial links on the corresponding hop. As also described above (e.g., with reference to FIG. 7), each one of the LOS MIMO links (H+V) (e.g., mmW link1, mmW link2, mmW link3, and mmW link 4) may convey the corresponding bandwidth part (B/4)/CC/channel (comprising H+V) from the overall band1 bandwidth (bandwidth is equal to B on the direct UE 708/network node 702 hop). These LOS MIMO links may have some level of mutual leakage/interference in space due to non-perfect LOS MIMO geometry/links separation. Correspondingly, in accordance with the aspects described herein, because applying Tx precoding and Rx MMSE combining on the repeaters side around LOS MIMO hop is not performed to avoid any need for local digital processing, this inter-links leakage takes place between different “CC”s/channels from the band1/E2E system perspective (e.g., at the transmit side of the network node 702 and the receive side of the UE 708 for downlink transmissions). That is, Tx precoding and Rx MMSE combining is not performed by the repeaters 704 and 706, but instead at the network node 702 and the UE 708, respectively. To guarantee a high error vector magnitude (EVM) on the overall multi-hop link, this inter-channel/“CC”s interference may be minimized by processing that may be done on the E2E Tx side (e.g., the transmit side of the network node 702) and E2E Rx side (e.g., the receive side of the UE 708) of the addressed multi-hop link (such that analog processing on the repeaters side will be preserved without utilizing digital processing).

In order to mitigate/minimize the inter-channel leakage/interference related to LOS MIMO on the intermediate hop, Tx precoding may be applied not only across the band1 H+V dimension (spatial precoding), but also across different frequency channels/BW parts/CCs from band1 (frequency precoding). Precoding over both space and frequency dimensions will allow to mitigate the inter-layers interference/leakage (introduced on the intermediate LOS MIMO hop) in an E2E manner and in a manner that is transparent for all the intermediate repeaters (e.g., the repeaters 704 and 706) (e.g., space-frequency precoding may be performed on the E2E Tx side).

In the example shown in FIG. 7, there may be 8×8 LOS MIMO (4 spatial links, each one with H+V) on the intermediate hop and, correspondingly, there may be 8 Tx antenna ports/layers to be addressed for E2E Tx precoding to be applied across these ports/layers. As also described above, different bandwidth parts/CCs/channels from the band1 bandwidth may be addressed as virtual Tx antennas, each one with 2 spatial ports (H+V). Applying this concept for the examples described above, a total of 4*2=8 Tx antenna ports are addressed for E2E Tx space-frequency precoding and transmission (in a manner that is transparent for the repeaters 704 and 706).

Complementary, on the E2E Tx side (band1), data input/modulated symbols may be split into 8 space-frequency streams correspondingly (e.g., a factor 4 split for virtual antennas and an additional factor 2 split for H and V layers) according to the number of spatial layers on the LOS MIMO hop. Hybrid space-frequency precoding (e.g., using an 8×8 precoding matrix) may be applied to these 8 input data vectors/streams such that all input data vectors/streams may be combined with the corresponding (and different per-data stream and per-Tx antenna port) precoding coefficients before transmission on each Tx antenna port (overall 8 antenna ports after virtual extension).

The space-frequency precoding (e.g., using an 8×8 matrix per resource element (RE), as described above) may be different for each RE from the bandwidth part/CC/channel (frequency-selective precoding) or may be the same across some number of REs or even the entire bandwidth part/CC/channel (wideband (WB) precoding). Intra-channel/CC (RE index) frequency-selective/WB-type of precoding may be applied differently over the spatial dimension (H and V) and over the channel index dimension (inter-channel frequency dimension).

Similar to the above-described space-frequency precoding procedures on the E2E Tx side, the E2E Rx side may apply space frequency MMSE combining. Following the same concept, because 8 space-frequency data streams are to be demodulated on the E2E Rx side, and given some residual leakage/interference between different bandwidth parts/CCs/channels (band1) not eliminated by the Tx space-frequency precoding, each bandwidth part/CC/channel may be addressed as a virtual Rx antenna on the receiver side (e.g., 4 virtual Rx antennas, each one represented by 2 physical Rx antennas mapped to H and V polarizations may result in overall 8 Rx antennas after the virtual extension). Space-frequency combining (e.g., MMSE combining) (using an 8×8 matrix per RE) may be applied across all the Rx antennas (after the virtual extension) in order to obtain 8 separated/equalized Rx data streams.

Various types of signaling may be utilized to implement the aspects of the present disclosure described above. For instance, a UE that supports space-frequency precoding and/or combining may signal, for example, to a network node that it has a capability to support space-frequency precoding and/or combining. The UE may also be made aware when to apply space-frequency precoding and/or combining from signaling from, for example, a network node (the hybrid band multi-hop link control may be provided via a PCell).

The channel bandwidth/BWP/CC (e.g., a frequency segment) size and/or virtualization factor (e.g., the number of virtual streams, the number of virtual Tx/Rx ports addressed across the frequency dimension) according to the LOS MIMO order on the intermediate hop may also be indicated via signaling. Such parameters and the LOS MIMO effective order (e.g., the number of spatial link) may be dynamic per established multi-hop link based on the UE allocation bandwidth in the Sub-THz band (e.g., the band1 bandwidth) and the applicable band combination/hybrid Tx scheme). The guard band size between the BWPs/channels/CCs may also be configurable and signaled (e.g., from the network node to the UE).

A repeater (e.g., the repeaters 704 and 706) may also utilize signaling. For instance, the repeater may provide dynamic signaling that indicates a number of used links (e.g., the LOS MIMO order). For example, if the repeater determines, based on its channel parameters, that its LOS MIMO functionality cannot transmit via 4 links, but instead can transmit via 2 links, the repeater may signal this, for example, to the network node. The repeater may also be provided signaling that indicates a selection of Tx/Rx beamformers/MIMO transmitters that are to be used when a lower number of links is involved compared to the maximum supported LOS MIMO geometry (in case of a partial UE allocation bandwidth on the first frequency band (e.g., band1)). That is, if there is no need for a maximum LOS MIMO order (e.g., when a certain UE has a lower bandwidth allocation over the Sub-THz band), then some of the MIMO links of the intermediate hop are not required (and thus may be shut down). In such a case, the repeater may be provided signaling, for example, by the network node, that indicates which MIMO links may be shut down/excluded. This indication may, for example, indicate MIMO dimensions (in terms of lens antennas/transmitters) that the repeater utilizes to shut down/exclude certain MIMO links. The determination as to which MIMO links are to be shut down/excluded may be based on other techniques. For instance, the determination may be based on mutual interference measurements between different links. Using these measurements, the more orthogonal links may be preserved, whereas the less orthogonal links may be shut down/excluded.

The aspects of the present disclosure advantageously preserve the analog nature of processing on the Sub-THZ smart repeater side for hybrid band multi-hop links with LOS MIMO on an intermediate hop. Such aspects may also move (or “project”) LOS MIMO hop-related Tx precoding and Rx MMSE combining procedures to the multi-hop link E2E Tx and Rx edges (e.g., at the network node and UE) to avoid any digital processing at the hybrid smart repeaters side support LOS MIMO link/hop. As such, the usage of hybrid frequency/band multi-hop links with LOS MIMO on an intermediate hop with analog processing (without digital processing) on the smart repeaters side advantageously results in a power efficient and a Sub-THz deployment with extended range. Moreover, such techniques introduce a space-frequency precoding and space frequency combining approach to support transparent MIMO processing at the intermediate repeaters supporting a LOS MIMO hope while hybrid frequency/band multi-hop links are employed.

The aspects of the present disclosure provide several advantages. For instance, such aspects provide extremely high Sub-THz link/spot capacity along with an increased link range/coverage spot size. Such aspects may also extend the coverage and range (e.g., via multi-hop repeating, dual frequency (Tx/Rx) repeaters, usage of lower frequency bands with higher range on some intermediate hops). Such aspects may also provide E2E/transparent MIMO transmission/reception procedures, thereby allowing analog processing (without digital processing) on the hybrid smart repeater side supporting LOS MIMO. Such aspects also provide improved power efficiency for a Sub-THz deployment and reduced power consumption, as analog repeater/AP designs without digital processing may be utilized. Such aspects may also provide a frequency-to-space/layers conversion (assisted by the E2E space-frequency precoding/combining approach described herein) that may reduce the overall bandwidth occupancy for a multi-hop hybrid frequency/band link. Such aspects may further reduce cross-layer interference related to LOS MIMO usage on an intermediate hop.

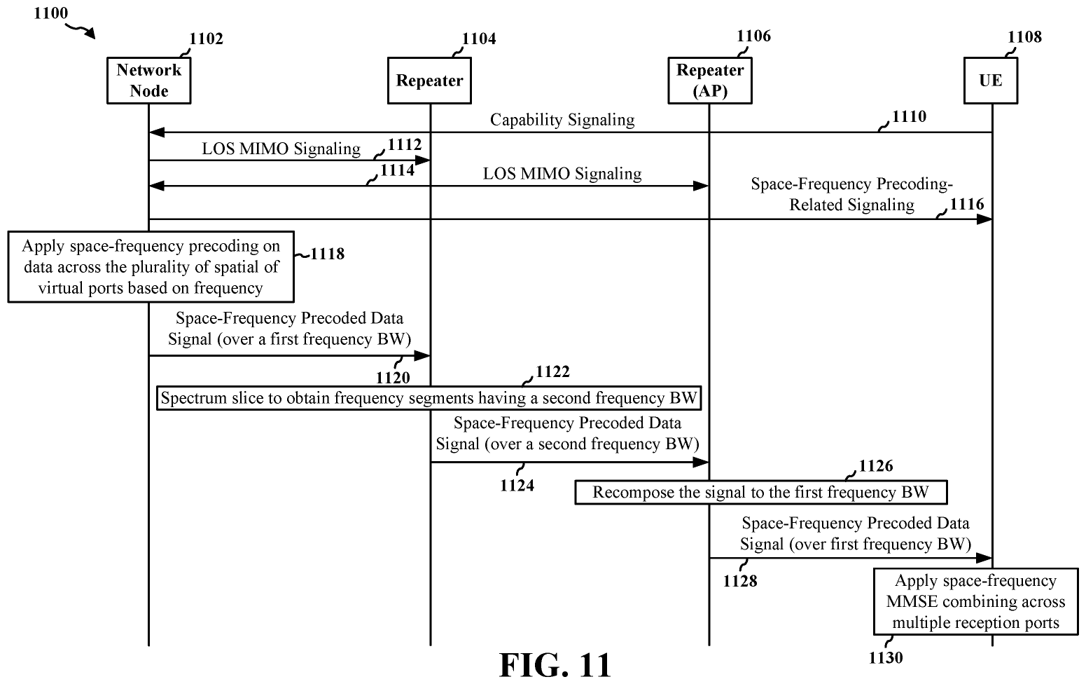

FIG. 11 is a call flow diagram 1100 illustrating a method of wireless communication in accordance with various aspects of this present disclosure. As shown in FIG. 11, the diagram 1100 includes a network node 1102, a repeater 1104, a repeater 1106, and a UE 1108. The network node 1102 may be an example of the network node 702, the repeater 1104 may be an example of the repeater 704, the repeater 1106 may be an example of the repeater (or access point) 706, and the UE 1108 may be an example of the UE 708, as respectively described above with reference to FIG. 7. In an aspect, the repeaters 1104 and 1106 may be analog repeaters. Although aspects are described for the network node 1102, the aspects may be performed by a network node in aggregation and/or by one or more components of the network node 1102 (e.g., such as a CU 110, a DU 130, and/or an RU 140). In the example shown in the diagram 1100, the network node 1102 is configured to apply space-frequency precoding and the UE 1108 is configured to apply space-frequency MMSE combining. As shown in FIG. 11, at 1110, the UE 1108 may provide signaling to the network node 1102 that indicates it has the capability to support space-frequency precoding and/or combining. In some aspects, the UE 1108 may provide the signaling in response to receiving an inquiry from the network node 1102.

At 1112 and 1114, the repeaters 1104 and 1106 may provide dynamic signaling to the network node 1102 that indicates a factor based on the number of links (e.g., the LOS MIMO order) utilized by a respective repeater to forward a signal.

In an aspect, at 1112 and 1114, the network node 1102 may provide signaling to the repeaters 1104 and 1106 indicating at least one of a first number of beamformers to be utilized by the repeaters 1104 and 1106 or a second number of LOS MIMO transmitters to be utilized by the repeaters 1104 and 1106, the first number and the second number being based on an allocation of the first frequency bandwidth by the UE 1108 and/or the network node 1102.

At 1116, the network node 1102 may provide space-frequency precoding-related signaling to the UE 1108. For instance, the signaling may indicate that the space-frequency precoding scheme is applied to data received by the UE 1108 and/or that an MMSE combining scheme is to be applied by the UE 1108 on data received by the UE 1108. The signaling may also indicate the frequency segment size of each of the plurality of frequency segments (e.g., channel bandwidth/BWP/CC), a virtualization factor (e.g., the number of virtual data streams supported by the repeaters 1104 and 1106, the number of spatial ports and virtual ports supported by the repeaters 1104 and 1106) according to the LOS MIMO order (indicated via the signaling received at 1112 and 1114) utilized by the repeaters 1104 and 1106, and/or the guard band size of a respective guard band between each of the plurality of frequency segments.

In some aspects, each of the plurality of frequency segments comprises two polarizations (e.g., a horizontal polarization and a vertical polarizations) applied in combination with the plurality of spatial ports and virtual ports.

At 1118, the network node 1102 may apply space-frequency precoding for across the plurality of spatial and virtual ports based on frequency over which the data is to be transmitted. For instance, the network node 1102 may decompose a frequency dimension into a plurality of frequency segments (e.g., virtual channels/CCs), where each of the plurality of frequency segments (e.g., CC BW chunk) corresponds to at least one of the virtual ports (and associated polarization ports (H and V ports)), and decompose the data into a plurality of virtual data streams (or layers) corresponding to the plurality of spatial ports and virtual ports based on the plurality of frequency segments. In the example shown in FIG. 7, there are two spatial ports (e.g., H and V ports) and 4 virtual ports, thereby resulting in a total of 8 Tx ports). The network node 1102 may then apply a precoding matrix (e.g., the precoding matrix 902) in accordance with the space-frequency precoding scheme to the plurality of virtual data streams across the plurality of spatial ports and virtual ports based on the plurality of frequency segments. For example, the network node 1102 may apply the precoding matrix to the virtual data streams (e.g., 8 virtual data streams) across all the Tx ports.

At 1120, the network node 1102 may transmit the space-frequency precoded data signal via the plurality of spatial ports and layers associated with the virtual ports to the repeater 1104 (e.g., over a first frequency bandwidth, such as a sub-THz frequency band).

At 1122, the repeater 1104 may perform spectrum slicing on the first frequency bandwidth to obtain smaller chunks/channels having a smaller, second frequency bandwidth. The smaller chunks/channels may be then applied to LOS MIMO transmitters (each having dual polarization per channel) of the repeater 1104. At 1124, the repeater 1104 may forward, without decoding, the space-frequency precoded data signal to the repeater 1106 (e.g., over the second frequency bandwidth, such as the mmW band) as a LOS MIMO signal. The over-the-air channel may combine all the links/layers, thereby introducing some cross-layer interference on the receiving side of the LOS MIMO link (e.g., at the repeater 1106) due to non-perfect LOS MIMO geometry/links separation.

At 1126, the repeater 1106 may receive the space-frequency precoded data signal and recompose the signal to the first frequency bandwidth. For example, the repeater 1106 may take the output of its LOS MIMO receivers and allocate it back into the corresponding frequency domain location on the first frequency bandwidth (e.g., the repeater 1106 re-spans back the frequency domain over the first frequency bandwidth).

At 1128, the repeater 1106 may transmit the recomposed space-frequency precoded data signal to the UE 1108 over the first frequency bandwidth.

At 1130, the UE 1108 may receive the recomposed space-frequency precoded data signal and may apply space-frequency MMSE combining across multiple reception ports of the UE 1108. For instance, prior to the space-frequency MMSE combining, the UE 1108 may decompose frequency dimensions of the signal into virtual frequency segments of the signal, where each virtual frequency segment corresponds to a virtual reception port comprised in the multiple reception ports. The UE 1108 may apply space-frequency MMSE combining across the multiple reception ports of the UE 1108 in order to derive separate virtual data streams and remove the cross-layer interference in the overall link.

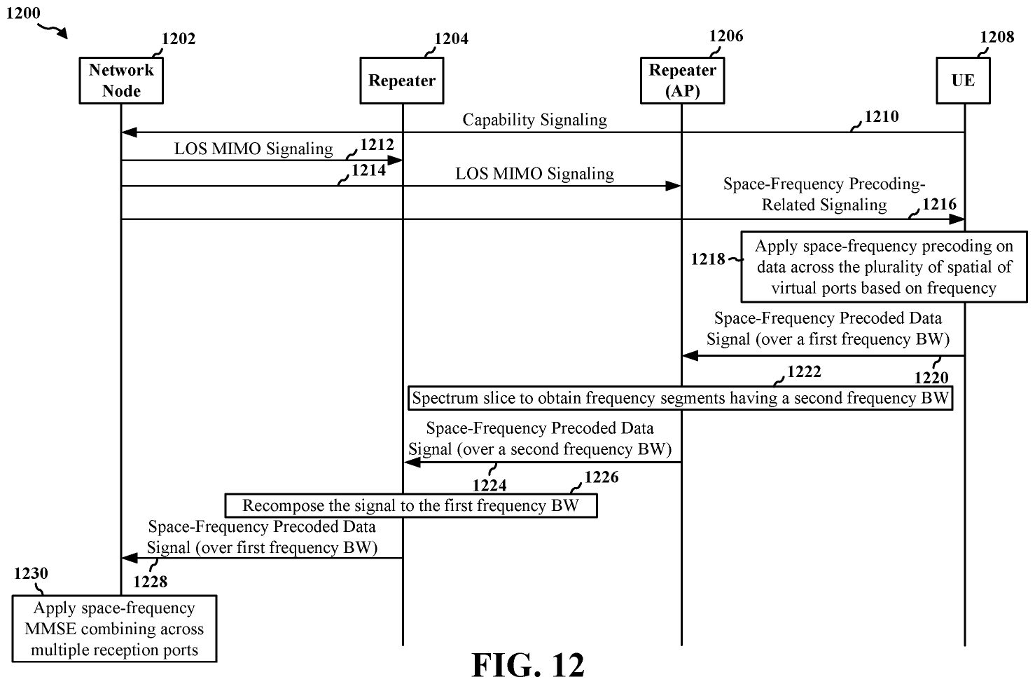

FIG. 12 is a call flow diagram 1200 illustrating a method of wireless communication in accordance with various aspects of this present disclosure. As shown in FIG. 12, the diagram 1200 includes a network node 1202, a repeater 1204, a repeater 1206, and a UE 1208. The network node 1202 may be an example of the network node 702, the repeater 1204 may be an example of the repeater 704, the repeater 1206 may be an example of the repeater (or access point) 706, and the UE 1208 may be an example of the UE 708, as respectively described above with reference to FIG. 7. In an aspect, the repeaters 1204 and 1206 may be analog repeaters. Although aspects are described for the network node 1202, the aspects may be performed by a network node in aggregation and/or by one or more components of the network node 1202 (e.g., such as a CU 110, a DU 130, and/or an RU 140). In the example shown in the diagram 1100, the UE 1208 is configured to apply space-frequency precoding and the network node 1202 is configured to apply space-frequency MMSE combining. As shown in FIG. 12, at 1210, the UE 1208 may provide signaling to the network node 1102 that indicates it has the capability to support space-frequency precoding and/or combining. In some aspects, the UE 1208 may provide the signaling in response to receiving an inquiry from the network node 1202.

At 1212 and 1214, the repeaters 1204 and 1206 may provide dynamic signaling to the network node 1202 that indicates a factor based on the number of links (e.g., the LOS MIMO order) utilized by a respective repeater to forward a signal.

In an aspect, at 1212 and 1212, the network node 1202 may provide signaling to the repeaters 1204 and 1206 indicating at least one of a first number of beamformers to be utilized by the repeaters 1204 and 1206 or a second number of LOS MIMO transmitters to be utilized by the repeaters 1204 and 1206, the first number and the second number being based on an allocation of the first frequency bandwidth by the UE 1108 and/or the network node 1102.

At 1216, the network node 1202 may provide space-frequency precoding-related signaling to the UE 1208. For instance, the signaling may indicate that the UE 1208 is to apply a space-frequency precoding scheme to data transmitted by the UE 1208 and/or that an MMSE combining scheme is to be applied by the UE 1208 on data received by the UE 1208. The signaling may also indicate the frequency segment size of each of the plurality of frequency segments (e.g., channel bandwidth/BWP/CC), a virtualization factor (e.g., the number of virtual data streams supported by the repeaters 1204 and 1206, the number of spatial ports and virtual ports supported by the repeaters 1204 and 1206) according to the LOS MIMO order (indicated via the signaling received at 1212 and 1214) utilized by the repeaters 1204 and 1206, and/or the guard band size of a respective guard band between each of the plurality of frequency segments.

In some aspects, each of the plurality of frequency segments comprises two polarizations (e.g., a horizontal polarization and a vertical polarizations) applied in combination with the plurality of spatial ports and virtual ports.

At 1218, the UE 1208 may apply space-frequency precoding for across the plurality of spatial and virtual ports based on frequency over which the data is to be transmitted. For instance, the UE 1208 may decompose a frequency dimension into a plurality of frequency segments (e.g., virtual channels/CCs), where each of the plurality of frequency segments (e.g., CC BW chunk) corresponds to at least one of the virtual ports (and associated polarization ports (H and V ports)), and decompose the data into a plurality of virtual data streams (or layers) corresponding to the plurality of spatial ports and virtual ports based on the plurality of frequency segments. In the example shown in FIG. 7, there are two spatial ports (e.g., H and V ports) and 4 virtual ports, thereby resulting in a total of 8 Tx ports). The UE 1208 may then apply a precoding matrix (e.g., the precoding matrix 902) in accordance with the space-frequency precoding scheme to the plurality of virtual data streams across the plurality of spatial ports and virtual ports based on the plurality of frequency segments. For example, the UE 1208 may apply the precoding matrix to the virtual data streams (e.g., 8 virtual data streams) across all the Tx ports.

At 1220, the UE 1208 may transmit the space-frequency precoded data signal via the plurality of spatial ports and layers associated with the virtual ports to the repeater 1206 (e.g., over a first frequency bandwidth, such as a sub-THz frequency band).

At 1222, the repeater 1206 may perform spectrum slicing on the first frequency bandwidth to obtain smaller chunks/channels having a smaller, second frequency bandwidth. The smaller chunks/channels may be then applied to LOS MIMO transmitters (each having dual polarization per channel) of the repeater 1206. At 1224, the repeater 1206 may forward, without decoding, the space-frequency precoded data signal to the repeater 1204 (e.g., over the second frequency bandwidth, such as the mmW band) as a LOS MIMO signal. The over-the-air channel may combine all the links/layers, thereby introducing some cross-layer interference on the receiving side of the LOS MIMO link (e.g., at the repeater 1204) due to non-perfect LOS MIMO geometry/links separation.

At 1226, the repeater 1204 may receive the space-frequency precoded data signal and recompose the signal to the first frequency bandwidth. For example, the repeater 1204 may take the output of its LOS MIMO receivers and allocate it back into the corresponding frequency domain location on the first frequency bandwidth (e.g., the repeater 1204 re-spans back the frequency domain over the first frequency bandwidth).

At 1228, the repeater 1204 may transmit the recomposed space-frequency precoded data signal to the network node 1202 over the first frequency bandwidth.

At 1230, the network node 1202 may receive the recomposed space-frequency precoded data signal and may apply space-frequency MMSE combining across multiple reception ports of the network node 1202. For instance, prior to the space-frequency MMSE combining, the network node 1202 may decompose frequency dimensions of the signal into virtual frequency segments of the signal, where each virtual frequency segment corresponds to a virtual reception port comprised in the multiple reception ports. The network node 1202 may apply space-frequency MMSE combining across the multiple reception ports of the network node 1202 in order to derive separate virtual data streams and remove the cross-layer interference in the overall link.

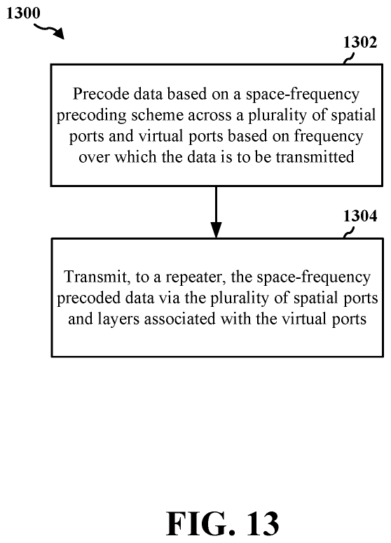

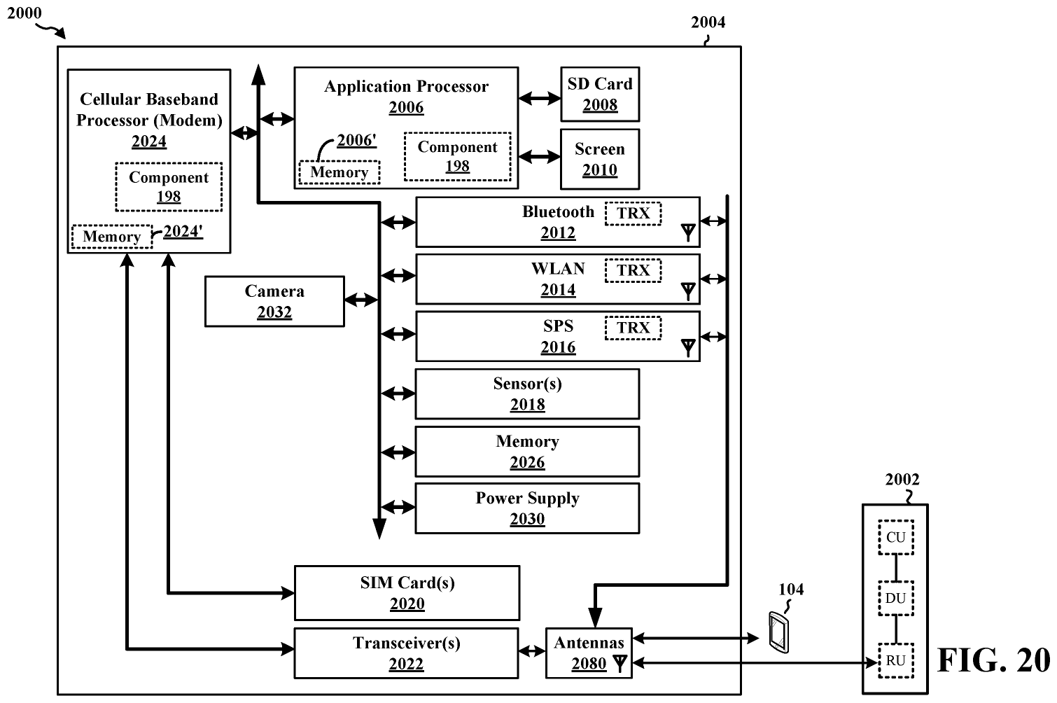

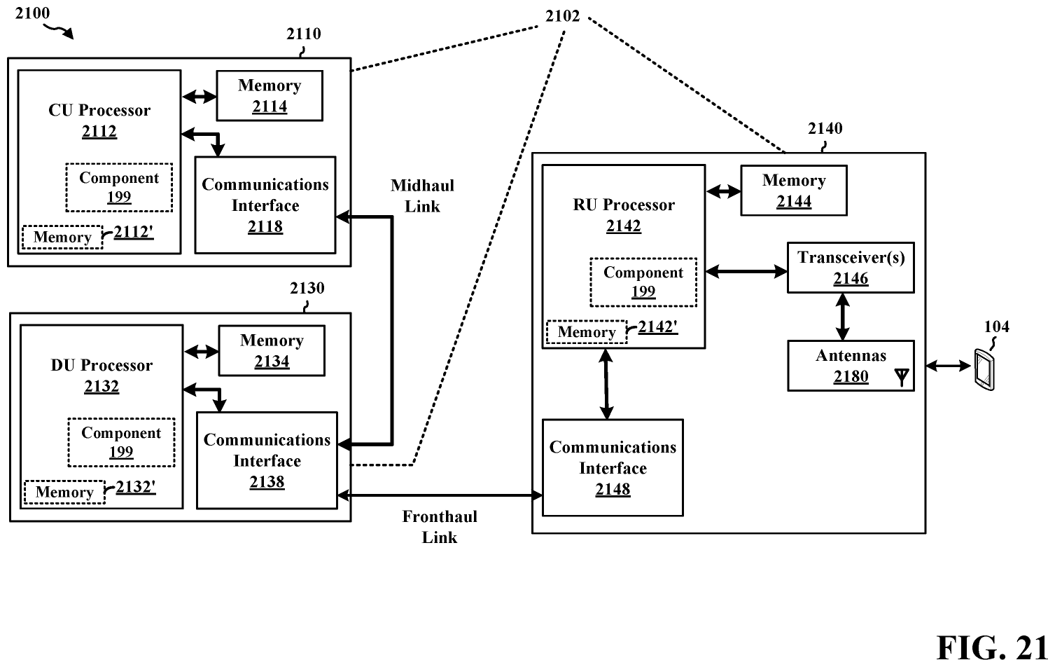

FIG. 13 is a flowchart 1300 illustrating methods of wireless communication at a wireless device in accordance with various aspects of the present disclosure. In some aspects, the wireless device may be a network node. The network node may be a base station, or a component of a base station, in the access network of FIG. 1 or a core network component (e.g., base station 102, 310; the CU 110, the DU 130; the RU 140; the network node 410, 510, 602, 702, 1102, or 1202; or the network entity 2102 in the hardware implementation of FIG. 21). In other aspects, the wireless device may be a UE. The UE may be the UE 104, 350, 412b, 412c, 606, 708, 1108, 1208, or the apparatus 2004 in the hardware implementation of FIG. 20.

At 1302, the wireless device may precode data based on a space-frequency precoding scheme across a plurality of spatial ports and virtual ports based on a frequency over which the data is to be transmitted. For example, referring to FIG. 11, in an aspect in which the wireless device is the network node 1102, the network node 1102, at 1118, may precode data based on a space-frequency precoding scheme across a plurality of spatial ports and virtual ports based on a frequency over which the data is to be transmitted. In another example, referring to FIG. 12, in an aspect in which the wireless device is the UE 1208, the UE 1208, at 1218, may precode data based on a space-frequency precoding scheme across a plurality of spatial ports and virtual ports based on a frequency over which the data is to be transmitted. In an aspect in which 1302 is performed by a network node, 1302 may be performed by the space-frequency precoding/combining component 199. In an aspect in which 1302 is performed by a UE, 1302 may be performed by the space-frequency precoding/combining component 198.

In an aspect, the wireless device may precode the data by decomposing a frequency dimension into a plurality of frequency segments, where each of the plurality of frequency segments corresponds to at least one of the virtual ports, and decomposing the data into a plurality of virtual data streams corresponding to the plurality of spatial ports and virtual ports based on the plurality of frequency segments, where the space-frequency precoding scheme is applied to the plurality of virtual data streams across the plurality of spatial ports and virtual ports based on the plurality of frequency segments. For example, referring to FIG. 11, in an aspect in which the wireless device is the network node 1102, the network node 1102 may precode the data by decomposing a frequency dimension into a plurality of frequency segments, where each of the plurality of frequency segments corresponds to at least one of the virtual ports, and decomposing the data into a plurality of virtual data streams corresponding to the plurality of spatial ports and virtual ports based on the plurality of frequency segments, where the space-frequency precoding scheme is applied to the plurality of virtual data streams across the plurality of spatial ports and virtual ports based on the plurality of frequency segments. In another example, referring to FIG. 12, in an aspect in which the wireless device is the UE 1208, the UE 1208 may precode the data by decomposing a frequency dimension into a plurality of frequency segments, where each of the plurality of frequency segments corresponds to at least one of the virtual ports, and decomposing the data into a plurality of virtual data streams corresponding to the plurality of spatial ports and virtual ports based on the plurality of frequency segments, where the space-frequency precoding scheme is applied to the plurality of virtual data streams across the plurality of spatial ports and virtual ports based on the plurality of frequency segments.

In an aspect, each of the plurality of frequency segments includes two polarizations applied in combination with the plurality of spatial ports and virtual ports. For example, referring to FIG. 11, in an aspect in which the wireless device is the network node 1102, the plurality of frequency segments determined for space-frequency precoding at 1118 may include two polarizations applied in combination with the plurality of spatial ports and virtual ports. In another example, referring to FIG. 12, in an aspect in which the wireless device is the UE 1208, the plurality of frequency segments determined for space-frequency precoding at 1218 may include two polarizations applied in combination with the plurality of spatial ports and virtual ports.

In an aspect, a first of the two polarizations is a horizontal polarization, and a second of the two polarizations is a vertical polarization. For example, referring to FIG. 11, in an aspect in which the wireless device is the network node 1102, the plurality of frequency segments determined for space-frequency precoding at 1118 may include a horizontal polarization and a vertical polarization. In another example, referring to FIG. 12, in an aspect in which the wireless device is the UE 1208, the plurality of frequency segments determined for space-frequency precoding at 1218 may include a horizontal polarization and a vertical polarization.

In an aspect, the wireless device may transmit or receive signaling further indicating at least one of a frequency segment size of each of the plurality of frequency segments, a virtualization factor based on an LOS MIMO order utilized by the repeater, or a guard band size of a respective guard band between each of the plurality of frequency segments. For example, referring to FIG. 11, in an aspect in which the wireless device is the network node 1102, the network node 1102, at 1116, may transmit signaling to the UE 1108 that indicates at least one of a frequency segment size of each of the plurality of frequency segments, a virtualization factor based on an LOS MIMO order utilized by the repeater 1104, or a guard band size of a respective guard band between each of the plurality of frequency segments. In another example, referring to FIG. 12, in an aspect in which the wireless device is the UE 1208, the UE 1208, at 1216, may receive signaling from the network node 1202 that indicates at least one of a frequency segment size of each of the plurality of frequency segments, a virtualization factor based on an LOS MIMO order utilized by the repeater 1206, or a guard band size of a respective guard band between each of the plurality of frequency segments.

In an aspect, the virtualization factor includes at least one of a first number of the plurality of virtual data streams supported by the repeater or a second number of the plurality of virtual data streams supported by the repeater. For example, referring to FIG. 11, in an aspect in which the wireless device is the network node 1102, the virtualization factor transmitted to the UE 1208 at 1216 may include at least one of a first number of the plurality of virtual data streams supported by the repeater 1104 or a second number of the plurality of virtual data streams supported by the repeater 1104. In another example, referring to FIG. 12, in an aspect in which the wireless device is the UE 1208, the virtualization factor received from the network node 1202 at 1216 may include at least one of a first number of the plurality of virtual data streams supported by the repeater 1206 or a second number of the plurality of virtual data streams supported by the repeater 1206.

In an aspect in which the wireless device is a network node, the network node may receive signaling indicating a factor based on an LOS MIMO order utilized by the repeater to forward the space-frequency precoded data to an additional wireless device. For example, referring to FIG. 11, in an aspect in which the wireless device is the network node 1102, the network node 1102, at 1112 and/or 1114, may receive signaling indicating a factor based on an LOS MIMO order utilized by a respective repeater (e.g., repeaters 1104 and 1106) to forward the space-frequency precoded data to an additional wireless device (e.g., the UE 1108).

In an aspect in which the wireless device is a network node, the network node may further receive an indication of support for the space-frequency precoding scheme. For example, referring to FIG. 11, the network node 1102 may further receive, at 1110, an indication of support for the space-frequency precoding scheme (and/or space-frequency MMSE combining scheme) from the UE 1108.

In an aspect in which the wireless device is a UE, the UE may further transmit an indication of support for the space-frequency precoding scheme. For example, referring to FIG. 12, the UE 1208 may further transmit, at 1210, an indication of support for the space-frequency precoding scheme (and/or space-frequency MMSE combining scheme) to the network node 1202.

In an aspect in which the wireless device is a UE, the UE may further receive signaling that indicates that the space-frequency precoding scheme is to be applied on data transmitted by the UE. For example, referring to FIG. 12, the UE 1208 may further receive, at 1216, signaling that indicates that the space-frequency precoding scheme is to be applied on data transmitted by the UE 1208.

In an aspect in which the wireless device is a UE, the UE may further receive signaling that indicates that an MMSE combining scheme is to be applied on data received by the UE. For example, referring to FIG. 12, the UE 1208 may further receive, at 1216, signaling that indicates that the MMSE combining scheme is to be applied on data received by the UE 1208.

At 1304, the wireless device may transmit, to a repeater, the space-frequency precoded data via the plurality of spatial ports and layers associated with the virtual ports. For example, referring to FIG. 11, in an aspect in which the wireless device is the network node 1102, the network node 1102, at 1120, may transmit, to the repeater 1104, the space-frequency precoded data via the plurality of spatial ports and layers associated with the virtual ports. In another example, referring to FIG. 12, in an aspect in which the wireless device is the UE 1208, the UE 1208, at 1220, may transmit, to the repeater 1206, the space-frequency precoded data via the plurality of spatial ports and layers associated with the virtual ports. In an aspect in which 1304 is performed by a network node, 1302 may be performed by the space-frequency precoding/combining component 199. In an aspect in which 1304 is performed by a UE, 1302 may be performed by the space-frequency precoding/combining component 198.

In an aspect, the wireless device may transmit the space-frequency precoded data via the plurality of spatial ports and layers associated with the virtual ports over a sub-THz frequency band. For example, referring to FIG. 11, in an aspect in which the wireless device is the network node 1102, the network node 1102, at 1120, may transmit the space-frequency precoded data to the repeater 1104 via the plurality of spatial ports and layers associated with the virtual ports over a sub-THz frequency band. In another example, referring to FIG. 12, in an aspect in which the wireless device is the UE 1208, the UE 1208, at 1220, may transmit the space-frequency precoded data to the repeater 1206 via the plurality of spatial ports and layers associated with the virtual ports over a sub-THz frequency band.

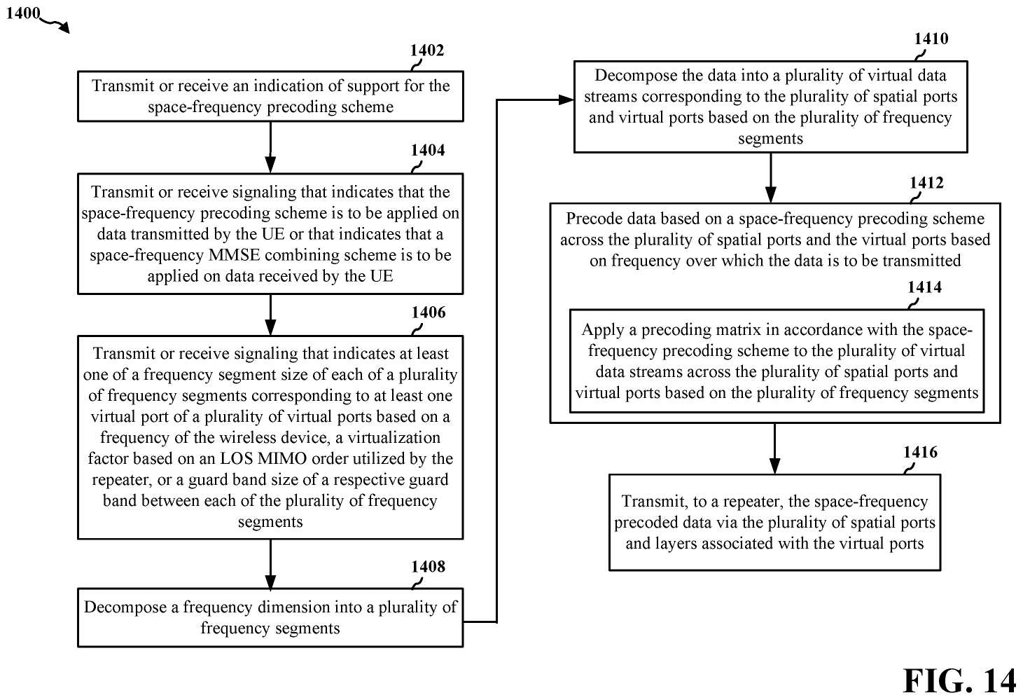

FIG. 14 is a flowchart 1400 illustrating methods of wireless communication at a wireless device in accordance with various aspects of the present disclosure. In some aspects, the wireless device may be a network node. The network node may be a base station, or a component of a base station, in the access network of FIG. 1 or a core network component (e.g., base station 102, 310; the CU 110, the DU 130; the RU 140; the network node 410, 510, 602, 702, 1102, or 1202; or the network entity 2102 in the hardware implementation of FIG. 21). In other aspects, the wireless device may be a UE. The UE may be the UE 104, 350, 412b, 412c, 606, 708, 1108, 1208, or the apparatus 2004 in the hardware implementation of FIG. 20.

At 1402, the wireless device may transmit or receive an indication of support for a space-frequency precoding scheme. For example, referring to FIG. 11, in an aspect in which the wireless device is the network node 1102, the network node 1102 may receive, at 1110, an indication of support for a space-frequency precoding scheme (and/or a space-frequency MMSE combining scheme) from the UE 1108. In another example, referring to FIG. 12, in an aspect in which the wireless device is the UE 1208, the UE 1208 may transmit, at 1210, an indication of support for the space-frequency precoding scheme (and/or a space-frequency MMSE combining scheme) to the network node 1202.

At 1404, the wireless device may transmit or receive signaling that indicates that the space-frequency precoding scheme is to be applied on data transmitted by the UE or that indicates that a space-frequency MMSE combining scheme is to be applied on data received by the UE. For example, referring to FIG. 11, in an aspect in which the wireless device is the network node 1102, the network node 1102 may, at 1116, transmit signaling that indicates that the space-frequency precoding scheme is to be applied on data transmitted by the UE 1108 or that indicates that a space-frequency MMSE combining scheme is to be applied on data received by the UE 1108. In another example, referring to FIG. 12, in an aspect in which the wireless device is the UE 1208, the UE 1208 may, at 1216, receive signaling that indicates that the space-frequency precoding scheme is to be applied on data transmitted by the UE 1208 or that indicates that a space-frequency MMSE combining scheme is to be applied on data received by the UE 1208.

At 1406, the wireless device may transmit or receive signaling further indicating at least one of a frequency segment size of each of a plurality of frequency segments corresponding to at least one virtual port of a plurality of virtual ports based on a frequency of the wireless device, a virtualization factor based on an LOS MIMO order utilized by the repeater, or a guard band size of a respective guard band between each of the plurality of frequency segments. For example, referring to FIG. 11, in an aspect in which the wireless device is the network node 1102, the network node 1102, at 1116, may transmit signaling to the UE 1108 that indicates at least one of a frequency segment size of each of the plurality of frequency segments, a virtualization factor based on an LOS MIMO order utilized by the repeater 1104, or a guard band size of a respective guard band between each of the plurality of frequency segments. In another example, referring to FIG. 12, in an aspect in which the wireless device is the UE 1208, the UE 1208, at 1216, may receive signaling from the network node 1202 that indicates at least one of a frequency segment size of each of the plurality of frequency segments, a virtualization factor based on an LOS MIMO order utilized by the repeater 1206, or a guard band size of a respective guard band between each of the plurality of frequency segments.

In an aspect, the virtualization factor includes at least one of a first number of the plurality of virtual data streams supported by the repeater or a second number of the plurality of virtual data streams supported by the repeater. For example, referring to FIG. 11, in an aspect in which the wireless device is the network node 1102, the virtualization factor transmitted to the UE 1108 at 1116 may include at least one of a first number of the plurality of virtual data streams supported by the repeater 1104 or a second number of the plurality of virtual data streams supported by the repeater 1104. In another example, referring to FIG. 12, in an aspect in which the wireless device is the UE 1208, the virtualization factor received by the UE 1208 at 1216 may include at least one of a first number of the plurality of virtual data streams supported by the repeater 1206 or a second number of the plurality of virtual data streams supported by the repeater 1206.

At 1408, the wireless device may decompose a frequency dimension into the plurality of frequency segments. For example, referring to FIG. 11, in an aspect in which the wireless device is the network node 1102, the network node 1102 may decompose a frequency dimension into the plurality of frequency segments. In another example, in an aspect in which the wireless device is the UE 1208, the UE 1208 may decompose a frequency dimension into the plurality of frequency segments.

At 1410, the wireless device may decompose data into a plurality of virtual data streams corresponding to the plurality of spatial ports and virtual ports based on the plurality of frequency segments. For example, referring to FIG. 11, in an aspect in which the wireless device is the network node 1102, the network node 1102 may decompose the data into a plurality of virtual data streams corresponding to the plurality of spatial ports and virtual ports based on the plurality of frequency segments. In another example, referring to FIG. 12, in an aspect in which the wireless device is the UE 1208, the UE 1208 may decompose the data into a plurality of virtual data streams corresponding to the plurality of spatial ports and virtual ports based on the plurality of frequency segments.

At 1412, the wireless device may precode the data based on a space-frequency precoding scheme across the plurality of spatial ports and the virtual ports based on frequency over which the data is to be transmitted. For example, referring to FIG. 11, in an aspect in which the wireless device is the network node 1102, the network node 1102, at 1118, may precode the data based on a space-frequency precoding scheme across a plurality of spatial ports and the virtual ports based on a frequency over which the data is to be transmitted. In another example, referring to FIG. 12, in an aspect in which the wireless device is the UE 1208, the UE 1208, at 1218, may precode the data based on a space-frequency precoding scheme (e.g., the scheme indicated at 1404) across a plurality of spatial ports and the virtual ports based on a frequency over which the data is to be transmitted.

As part of 1412, at 1414, the wireless device may apply a precoding matrix in accordance with the space-frequency precoding scheme to the plurality of virtual data streams across the plurality of spatial ports and virtual ports based on the plurality of frequency segments. For example, referring to FIG. 11, in an aspect in which the wireless device is the network node 1102, the network node 1102, at 1118, may apply the precoding matrix (e.g., the precoding matrix 902) to the plurality of virtual data streams across the plurality of spatial ports and virtual ports based on the plurality of frequency segments. In another example, referring to FIG. 12, in an aspect in which the wireless device is the UE 1208, the UE 1208, at 1218, may apply the precoding matrix (e.g., the precoding matrix 902) to the plurality of virtual data streams across the plurality of spatial ports and virtual ports based on the plurality of frequency segments.

In an aspect, each of the plurality of frequency segments includes two polarizations applied in combination with the plurality of spatial ports and virtual ports. For example, referring to FIG. 11, in an aspect in which the wireless device is the network node 1102, the plurality of frequency segments obtained for space-frequency precoding at 1118 may include two polarizations applied in combination with the plurality of spatial ports and virtual ports. In another example, referring to FIG. 12, in an aspect in which the wireless device is the UE 1208, the plurality of frequency segments obtained for space-frequency precoding at 1218 may include two polarizations applied in combination with the plurality of spatial ports and virtual ports.

In an aspect, a first of the two polarizations is a horizontal polarization, and a second of the two polarizations is a vertical polarization. For example, referring to FIG. 11, in an aspect in which the wireless device is the network node 1102, the plurality of frequency segments obtained for space-frequency precoding at 1118 may include a horizontal polarization and a vertical polarization. In another example, referring to FIG. 12, in an aspect in which the wireless device is the UE 1208, the plurality of frequency segments obtained for space-frequency precoding at 1218 may include a horizontal polarization and a vertical polarization.

At 1416, the wireless device may transmit, to a repeater, the space-frequency precoded data via the plurality of spatial ports and layers associated with the virtual ports. For example, referring to FIG. 11, in an aspect in which the wireless device is the network node 1102, the network node 1102, at 1120, may transmit, to the repeater 1104, the space-frequency precoded data via the plurality of spatial ports and layers associated with the virtual ports. In another example, referring to FIG. 12, in an aspect in which the wireless device is the UE 1208, the UE 1208, at 1220, may transmit, to the repeater 1206, the space-frequency precoded data via the plurality of spatial ports and layers associated with the virtual ports.

In an aspect, the wireless device may transmit the space-frequency precoded data via the plurality of spatial ports and layers associated with the virtual ports over a sub-THz frequency band. For example, referring to FIG. 11, in an aspect in which the wireless device is the network node 1102, the network node 1102, at 1120, may transmit the space-frequency precoded data to the repeater 1104 via the plurality of spatial ports and layers associated with the virtual ports over a sub-THz frequency band. In another example, referring to FIG. 12, in an aspect in which the wireless device is the UE 1208, the UE 1208, at 1220, may transmit the space-frequency precoded data to the repeater 1206 via the plurality of spatial ports and layers associated with the virtual ports over a sub-THz frequency band.

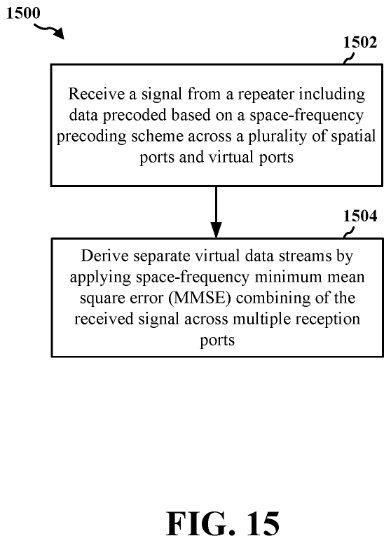

FIG. 15 is a flowchart 1500 illustrating methods of wireless communication at a wireless device in accordance with various aspects of the present disclosure. In some aspects, the wireless device may be a network node. The network node may be a base station, or a component of a base station, in the access network of FIG. 1 or a core network component (e.g., base station 102, 310; the CU 110, the DU 130; the RU 140; the network node 410, 510, 602, 702, 1102, or 1202; or the network entity 2102 in the hardware implementation of FIG. 21). In other aspects, the wireless device may be a UE. The UE may be the UE 104, 350, 412b, 412c, 606, 708, 1108, 1208, or the apparatus 2004 in the hardware implementation of FIG. 20.

At 1502, the wireless device may receive a signal from a repeater including data precoded based on a space-frequency precoding scheme across a plurality of spatial ports and virtual ports. For example, referring to FIG. 11, in an aspect in which the wireless device is the UE 1108, the UE 1108, at 1128, may receive a signal from the repeater 1106 including data precoded based on a space-frequency precoding scheme across a plurality of spatial ports and virtual ports (e.g., of the network node 1102). In another example, referring to FIG. 12, in an aspect in which the wireless device is the network node 1202, the network node 1202, at 1228, may receive a signal from the repeater 1204 including data precoded based on a space-frequency precoding scheme across a plurality of spatial ports and virtual ports (e.g., of the UE 1208). In an aspect in which 1502 is performed by a UE, 1502 may be performed by the space-frequency precoding/combining component 198. In an aspect in which 1502 is performed by a network node, 1502 may be performed by the space-frequency precoding/combining component 199.

At 1504, the wireless device may derive separate virtual data streams by applying space-frequency MMSE combining of the received signal across multiple receptions points. For example, referring to FIG. 11, in an aspect in which the wireless device is the UE 1108, the UE 1108, at 1130, may derive separate virtual data streams by applying space-frequency MMSE combining of the received signal across multiple receptions points. In another example, referring to FIG. 12, in an aspect in which the wireless device is the network node 1202, the network node 1202, at 1230, may derive separate virtual data streams by applying space-frequency MMSE combining of the received signal across multiple receptions points. In an aspect in which 1504 is performed by a UE, 1504 may be performed by the space-frequency precoding/combining component 198. In an aspect in which 1506 is performed by a network node, 1506 may be performed by the space-frequency precoding/combining component 199.

In an aspect, the wireless device may decompose, prior to the space-frequency MMSE combining, frequency dimensions of the signal into virtual frequency segments of the signal, where each virtual frequency segment corresponds to a virtual reception port comprised in the multiple reception ports. For example, referring to FIG. 11, in an aspect in which the wireless device is the UE 1108, the UE 1108 may decompose, prior to the space-frequency MMSE combining at 1130, frequency dimensions of the signal into virtual frequency segments of the signal, where each virtual frequency segment corresponds to a virtual reception port comprised in the multiple reception ports. In another example, referring to FIG. 12, in an aspect in which the wireless device is the network node 1202, the network node 1202 may decompose, prior to the space-frequency MMSE combining at 1230, frequency dimensions of the signal into virtual frequency segments of the signal, where each virtual frequency segment corresponds to a virtual reception port comprised in the multiple reception ports.

In an aspect, each of the virtual frequency segments includes two polarizations applied in combination with the plurality of spatial ports and virtual ports. For example, referring to FIG. 11, in an aspect in which the wireless device is the UE 1108, the virtual frequency segments determined for space-frequency MMSE combining at 1130 may include two polarizations applied in combination with the plurality of spatial ports and virtual ports. In another example, referring to FIG. 12, in an aspect in which the wireless device is the network node 1202, the virtual frequency segments determined for space-frequency MMSE combining at 1230 may include two polarizations applied in combination with the plurality of spatial ports and virtual ports.

In an aspect, a first of the two polarizations is a horizontal polarization, and a second of the two polarizations is a vertical polarization. For example, referring to FIG. 11, in an aspect in which the wireless device is the UE 1108, the virtual frequency segments determined for space-frequency MMSE combining at 1130 may include a horizontal polarization and a vertical polarization. In another example, referring to FIG. 12, in an aspect in which the wireless device is the network node 1202, the virtual frequency segments determined for space-frequency MMSE combining at 1230 may include a horizontal polarization and a vertical polarization.

In an aspect in which the wireless device is a UE, the UE may transmit an indication of support for the space-frequency precoding scheme prior to receiving the signal. For example, referring to FIGS. 11 and 12, the UE 1108 or 1208 may, at 1110 or 1210, transmit an indication of support for the space-frequency precoding scheme prior to receiving the signal.

In an aspect, the wireless device may receive signaling that indicates that the space-frequency precoding scheme is applied to the signal. For example, referring to FIG. 11, in an aspect in which the wireless device is the UE 1108, the UE 1108, at 1116, may receive signaling that indicates that the space-frequency precoding scheme is applied to the signal received at 1128.

In an aspect, the wireless device may receive signaling that indicates at least one of a frequency segment size of each of the virtual frequency segments, a virtualization factor based on an LOS MIMO order utilized by the repeater, or a guard band size of a respective guard band between each of the virtual frequency segments. For example, referring to FIG. 11, in an aspect in which the wireless device is the UE 1108, the UE 1108, at 1116, may receiving signaling that indicates at least one of a frequency segment size of each of the virtual frequency segments, a virtualization factor based on an LOS MIMO order utilized by the repeater 1106, or a guard band size of a respective guard band between each of the virtual frequency segments.

In an aspect, the virtualization factor includes at least one of a first number of a plurality of virtual data streams supported by the repeater or a second number of the plurality of spatial ports and virtual ports supported by the repeater. For example, referring to FIG. 11, in an aspect in which the wireless device is the UE 1108, the virtualization factor transmitted to the UE 1108 at 1116 may include at least one of a first number of the plurality of virtual data streams supported by the repeater 1106 or a second number of the plurality of virtual data streams supported by the repeater 1106.

In an aspect, the wireless device is a UE that may receive the signal from a network node via the repeater. For example, referring to FIG. 11, in an aspect in which the wireless device is the UE 1108, the UE 1108 may receive the signal at 1128 from the network node 1102 via the repeater 1106.

In an aspect, the wireless device is a network node that may receive the signal from the UE via the repeater. For example, referring to FIG. 12, in an aspect in which the wireless device is the network node 1202, the network node 1202 may, at 1228, receive the signal from the UE 1208 via the repeater 1204.

In an aspect, the data may be received via the multiple reception ports over a sub-THz frequency band. For example, referring to FIG. 11, in an aspect in which the wireless device is the UE 1108, the data may be received via multiple reception ports of the UE 1108 over a sub-THz band. In another example, referring to FIG. 12, in an aspect in which the wireless device is the network node 1202, the data may be received via multiple reception ports of the network node 1202 over a sub-THz band.

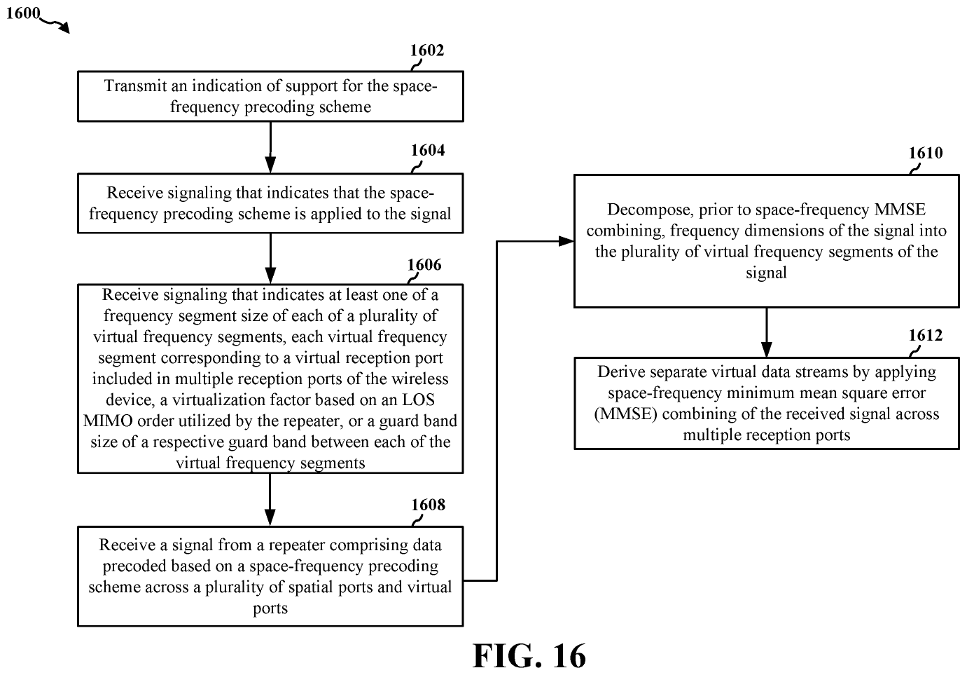

FIG. 16 is a flowchart 1600 illustrating methods of wireless communication at a wireless device in accordance with various aspects of the present disclosure. In some aspects, the wireless device may be a network node. The network node may be a base station, or a component of a base station, in the access network of FIG. 1 or a core network component (e.g., base station 102, 310; the CU 110, the DU 130; the RU 140; the network node 410, 510, 602, 702, 1102, or 1202; or the network entity 2102 in the hardware implementation of FIG. 21). In other aspects, the wireless device may be a UE. The UE may be the UE 104, 350, 412b, 412c, 606, 708, 1108, 1208, or the apparatus 2004 in the hardware implementation of FIG. 20.

At 1602, the wireless device may transmit an indication of support for the space-frequency precoding scheme. For example, referring to FIGS. 11 and 12, in an aspect in which the wireless device is the UE 1108 or 1208, the UE 1108 or 1208 may, at 1110 or 1210, transmit an indication of support for the space-frequency precoding scheme prior to receiving the signal.

At 1604, the wireless device may receive signaling that indicates that the space-frequency precoding scheme is applied to the signal. For example, referring to FIG. 11, in an aspect in which the wireless device is the UE 1108, the UE 1108, at 1116, may receive signaling that indicates that the space-frequency precoding scheme is applied to the signal received at 1128.

At 1606, the wireless device may receive signaling that indicates at least one of a frequency segment size of each of a plurality of virtual frequency segments, each virtual frequency segment corresponding to a virtual reception port included in multiple reception ports of the wireless device, a virtualization factor based on an LOS MIMO order utilized by the repeater, or a guard band size of a respective guard band between each of the virtual frequency segments. For example, referring to FIG. 11, in an aspect in which the wireless device is the UE 1108, the UE 1108, at 1116, may receiving signaling that indicates at least one of a frequency segment size of each of a plurality of virtual frequency segments, each virtual frequency segment corresponding to a virtual reception port included in multiple reception ports of the wireless device, a virtualization factor based on an LOS MIMO order utilized by the repeater 1106, or a guard band size of a respective guard band between each of the virtual frequency segments.

In an aspect, the virtualization factor includes at least one of a first number of a plurality of virtual data streams supported by the repeater or a second number of the plurality of spatial ports and virtual ports supported by the repeater. For example, referring to FIG. 11, in an aspect in which the wireless device is the UE 1108, the virtualization factor transmitted to the UE 1108 at 1116 may include at least one of a first number of the plurality of virtual data streams supported by the repeater 1106 or a second number of the plurality of virtual data streams supported by the repeater 1106.

At 1608, the wireless device may receive a signal from a repeater comprising data precoded based on a space-frequency precoding scheme across a plurality of spatial ports and virtual ports. For example, referring to FIG. 11, in an aspect in which the wireless device is the UE 1108, the UE 1108, at 1128, may receive a signal from the repeater 1106 including data precoded based on a space-frequency precoding scheme across a plurality of spatial ports and virtual ports (e.g., of the network node 1102). In another example, referring to FIG. 12, in an aspect in which the wireless device is the network node 1202, the network node 1202, at 1228, may receive a signal from the repeater 1204 including data precoded based on a space-frequency precoding scheme across a plurality of spatial ports and virtual ports (e.g., of the UE 1208).

At 1610, the wireless device may decompose, prior to the space-frequency MMSE combining, frequency dimensions of the signal into the plurality of virtual frequency segments of the signal. For example, referring to FIG. 11, in an aspect in which the wireless device is the UE 1108, the UE 1108 may decompose, prior to the space-frequency MMSE combining at 1130, frequency dimensions of the signal into the plurality of virtual frequency segments of the signal. In another example, referring to FIG. 12, in an aspect in which the wireless device is the network node 1202, the network node 1202 may decompose, prior to the space-frequency MMSE combining at 1230, frequency dimensions of the signal into the plurality of virtual frequency segments of the signal.

In an aspect, each of the virtual frequency segments includes two polarizations applied in combination with the plurality of spatial ports and virtual ports. For example, referring to FIG. 11, in an aspect in which the wireless device is the UE 1108, the virtual frequency segments determined for space-frequency MMSE combining at 1130 may include two polarizations applied in combination with the plurality of spatial ports and virtual ports. In another example, referring to FIG. 12, in an aspect in which the wireless device is the network node 1202, the virtual frequency segments determined for space-frequency MMSE combining at 1230 may include two polarizations applied in combination with the plurality of spatial ports and virtual ports.

In an aspect, a first of the two polarizations is a horizontal polarization, and a second of the two polarizations is a vertical polarization. For example, referring to FIG. 11, in an aspect in which the wireless device is the UE 1108, the virtual frequency segments determined for space-frequency MMSE combining at 1130 may include a horizontal polarization and a vertical polarization. In another example, referring to FIG. 12, in an aspect in which the wireless device is the network node 1202, the virtual frequency segments determined for space-frequency MMSE combining at 1230 may include a horizontal polarization and a vertical polarization.

At 1612, the wireless device may derive separate virtual data streams by applying space-frequency MMSE combining of the received signal across multiple receptions points. For example, referring to FIG. 11, in an aspect in which the wireless device is the UE 1108, the UE 1108, at 1130, may derive separate virtual data streams by applying space-frequency MMSE combining of the received signal across multiple receptions points. In another example, referring to FIG. 12, in an aspect in which the wireless device is the network node 1202, the network node 1202, at 1230, may derive separate virtual data streams by applying space-frequency MMSE combining of the received signal across multiple receptions points.

In an aspect, the wireless device is a UE that may receive the signal from a network node via the repeater. For example, referring to FIG. 11, in an aspect in which the wireless device is the UE 1108, the UE 1108 may receive the signal at 1128 from the network node 1102 via the repeater 1106.

In an aspect, the wireless device is a network node that may receive the signal from the UE via the repeater. For example, referring to FIG. 12, in an aspect in which the wireless device is the network node 1202, the network node 1202 may, at 1228, receive the signal from the UE 1208 via the repeater 1204.

In an aspect, the data may be received via the multiple reception ports over a sub-THz frequency band. For example, referring to FIG. 11, in an aspect in which the wireless device is the UE 1108, the data may be received via multiple reception ports of the UE 1108 over a sub-THz band. In another example, referring to FIG. 12, in an aspect in which the wireless device is the network node 1202, the data may be received via multiple reception ports of the network node 1202 over a sub-THz band.

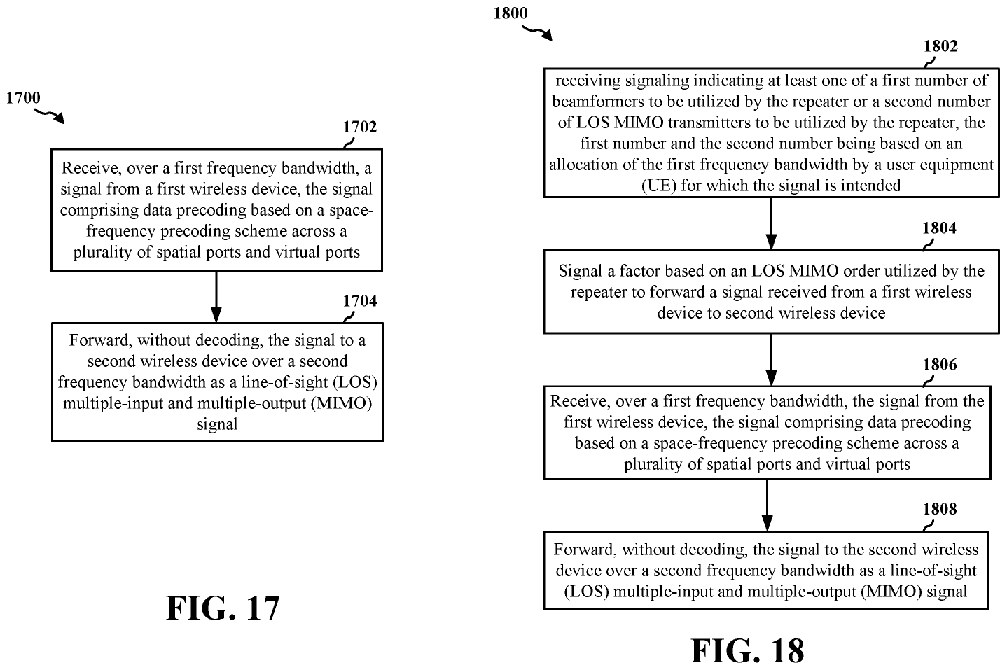

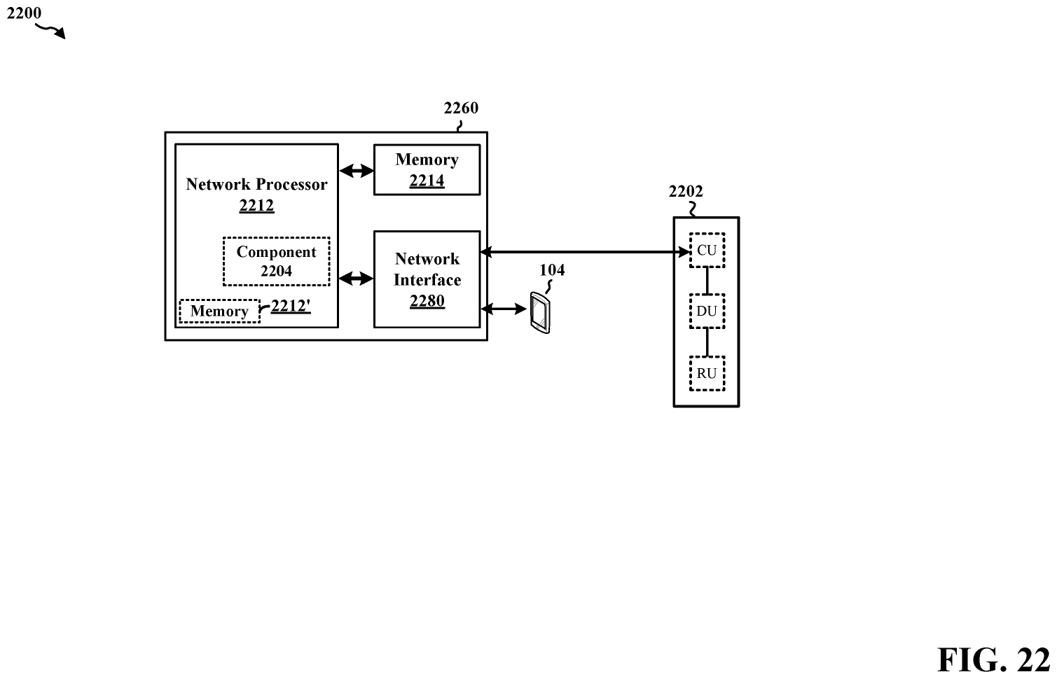

FIG. 17 is a flowchart 1700 illustrating methods of wireless communication at a repeater in accordance with various aspects of the present disclosure. The repeater may be the repeater 402b, 402c, 502b, 502c, 704, 706, 1104, 1106, 1204, or 1206; or the network entity 2260 in the hardware implementation of FIG. 22).

At 1702, the repeater may receive, over a first frequency bandwidth, a signal from a first wireless device, the signal comprising data precoding based on a space-frequency precoding scheme across a plurality of spatial ports and virtual ports. For example, referring to FIG. 11, in an aspect in which the signal is received by the repeater 1104, the repeater 1104 may, at 1120, receive, over a first frequency bandwidth, a signal from a first wireless device, the signal comprising data precoding based on a space-frequency precoding scheme across a plurality of spatial ports and virtual ports. In another example, referring to FIG. 12, in an aspect in which the signal is received by the repeater 1206, the repeater 1206 may, at 1220, receive, over a first frequency bandwidth, a signal from a first wireless device, the signal comprising data precoding based on a space-frequency precoding scheme across a plurality of spatial ports and virtual ports. In an aspect, 1702 may be performed by a component 2204 of the network processor 2212, as described below with reference to FIG. 22.

At 1704, the repeater may forward, without decoding, the signal to a second wireless device over a second frequency bandwidth as an LOS MIMO signal. For example, referring to FIG. 11, in an aspect in which the signal is forwarded by the repeater 1104, the repeater 1104 may, at 1124, forward, without decoding, the signal to a second wireless device over a second frequency bandwidth as an LOS MIMO signal. In another example, referring to FIG. 12, in an aspect in which the signal is forwarded by the repeater 1206, the repeater 1206 may, at 1224, forward, without decoding, the signal to a second wireless device over a second frequency bandwidth as an LOS MIMO signal. In an aspect, 1704 may be performed by the component 2204 of the network processor 2212, as described below with reference to FIG. 22.

In an aspect, the first wireless device is a network node and the second wireless device is a repeater/AP. For example, referring to FIG. 11, the first wireless device is the network node 1102 and the second wireless device is the repeater 1106.

In an aspect, the first wireless device is a UE and the second wireless device is an additional repeater. For example, referring to FIG. 12, the first wireless device is the UE 1208 and the second wireless device is the repeater 1204.

In an aspect, the repeater may signal a factor based on an LOS MIMO order utilized by the repeater to forward the signal to the second wireless device. For example, referring to FIG. 11, the repeater 1104, at 1112, may signal a factor based on an LOS MIMO order utilized by the repeater 1104 to forward the signal to the second wireless device (e.g., the repeater 1106) at 1124. In another example, referring to FIG. 12, the repeater 1206, at 1214, may signal a factor based on an LOS MIMO order utilized by the repeater 1206 to forward the signal to the second wireless device (e.g., the repeater 1204) at 1224.

In an aspect, the repeater may receive signaling indicating at least one of a first number of beamformers to be utilized by the repeater or a second number of LOS MIMO transmitters to be utilized by the repeater, the first number and the second number being based on an allocation of the first frequency bandwidth by a user equipment (UE) for which the signal is intended. For example, referring to FIG. 11, in an aspect in which the repeater is the repeater 1104, the repeater 1104, at 1112, may receive signaling indicating at least one of a first number of beamformers to be utilized by the repeater 1104 or a second number of LOS MIMO transmitters to be utilized by the repeater 1104, the first number and the second number being based on an allocation of the first frequency bandwidth by the UE 1108 for which the signal transmitted at 1120 is intended.

In an aspect, the repeater may be an analog repeater. For example, referring to FIG. 11, in an aspect in which the repeater is the repeater 1104, the repeater 1104 may be an analog repeater. In another example, referring to FIG. 12, in an aspect in which the repeater is the repeater 1204, the repeater 1204 may be an analog repeater.

FIG. 18 is a flowchart 1800 illustrating methods of wireless communication at an access point in accordance with various aspects of the present disclosure. The repeater may be the repeater 402b, 402c, 502b, 502c, 704, 706, 1104, 1106, 1204, or 1206; or the network entity 2260 in the hardware implementation of FIG. 22).

At 1802, the repeater may receive signaling indicating at least one of a first number of beamformers to be utilized by the repeater or a second number of LOS MIMO transmitters to be utilized by the repeater, the first number and the second number being based on an allocation of the first frequency bandwidth by a UE for which the signal is intended. For example, referring to FIG. 11, in an aspect in which the repeater is the repeater 1104, the repeater 1104, at 1112, may receive signaling indicating at least one of a first number of beamformers to be utilized by the repeater 1104 or a second number of LOS MIMO transmitters to be utilized by the repeater 1104, the first number and the second number being based on an allocation of the first frequency bandwidth by the UE 1108 for which the signal transmitted at 1120 is intended.

At 1804, the repeater may signal a factor based on an LOS MIMO order utilized by the repeater to forward a signal received from a first wireless device to second wireless device. For example, referring to FIG. 11, in an aspect in which the repeater is the repeater 1104, the repeater 1104, at 1112, may signal a factor based on an LOS MIMO order utilized by the repeater 1104 to forward a signal received from a first wireless device to second wireless device. In another example, referring to FIG. 12, in an aspect in which the repeater is the repeater 1206, the repeater 1206, at 1214, may signal a factor based on an LOS MIMO order utilized by the repeater 1206 to forward a signal received from a first wireless device to second wireless device.

At 1806, the repeater may receive, over a first frequency bandwidth, the signal from the first wireless device, the signal comprising data precoding based on a space-frequency precoding scheme across a plurality of spatial ports and virtual ports. For example, referring to FIG. 11, in an aspect in which the repeater is repeater 1104, the repeater 1104 may, at 1120, receive, over a first frequency bandwidth, the signal from the first wireless device (e.g., the network node 1102), the signal comprising data precoding based on a space-frequency precoding scheme across a plurality of spatial ports and virtual ports. In another example, referring to FIG. 12, in an aspect in which the repeater is repeater 1206, the repeater 1206 may, at 1220, receive, over a first frequency bandwidth, the signal from the first wireless device (e.g., the UE 1208), the signal comprising data precoding based on a space-frequency precoding scheme across a plurality of spatial ports and virtual ports.

At 1808, the repeater may forward, without decoding, the signal to the second wireless device over a second frequency bandwidth as an LOS MIMO signal. For example, referring to FIG. 11, in an aspect in which the repeater is the repeater 1104, the repeater 1104 may, at 1124, forward, without decoding, the signal to the second wireless device (e.g., the repeater 1106) over a second frequency bandwidth as an LOS MIMO signal. In another example, referring to FIG. 12, in an aspect in which the repeater is the repeater 1206, the repeater 1206 may, at 1224, forward, without decoding, the signal to the second wireless device (e.g., the repeater 1204) over a second frequency bandwidth as an LOS MIMO signal.

In an aspect, the first wireless device is a network node and the second wireless device is a repeater/AP. For example, referring to FIG. 11, the first wireless device is the network node 1102 and the second wireless device is the repeater 1106.

In an aspect, the first wireless device is a UE and the second wireless device is an additional repeater. For example, referring to FIG. 12, the first wireless device is the UE 1208 and the second wireless device is the repeater 1204.

In an aspect, the repeater may be an analog repeater. For example, referring to FIG. 11, in an aspect in which the repeater is the repeater 1104, the repeater 1104 may be an analog repeater. In another example, referring to FIG. 12, in an aspect in which the repeater is the repeater 1204, the repeater 1204 may be an analog repeater.

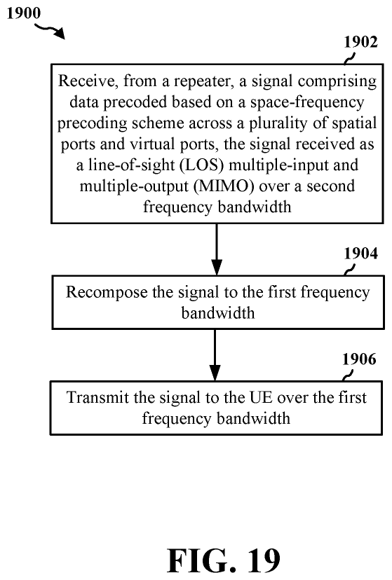

FIG. 19 is a flowchart 1900 illustrating methods of wireless communication at an access point that supports multiple hop wireless communication for a UE over a first frequency bandwidth in accordance with various aspects of the present disclosure. The access point may be the repeater 402c, 502c, 706, 1106, or 1206; or the network entity 2260 in the hardware implementation of FIG. 22).

At 1902, the access point may receive from a repeater, a signal comprising data precoded based on a space-frequency precoding scheme across a plurality of spatial ports and virtual ports, the signal received as an LOS MIMO over a second frequency bandwidth. For example, referring to FIG. 11, the repeater 1106 may, at 1124, receive from the repeater 1104, a signal comprising data precoded based on a space-frequency precoding scheme across a plurality of spatial ports and virtual ports, the signal received as an LOS MIMO over a second frequency bandwidth. In an aspect, 1902 may be performed by the component 2204 of the network processor 2212, as described below with reference to FIG. 22.

At 1904, the access point may recompose the signal to the first frequency bandwidth. For example, referring to FIG. 11, the repeater 1106, at 1126, may recompose the signal received at 1124 to the first frequency bandwidth. In an aspect, 1904 may be performed by the component 2204 of the network processor 2212, as described below with reference to FIG. 22.

At 1906, the access point may transmit the signal to the UE over the first frequency bandwidth. For example, referring to FIG. 11, the repeater 1106, at 1128, may transmit the signal to the UE 1108 over the first frequency bandwidth. In an aspect, 1906 may be performed by the component 2204 of the network processor 2212, as described below with reference to FIG. 22.

In an aspect, the first frequency bandwidth is a sub-THz frequency bandwidth. For example, referring to FIG. 11, the first frequency bandwidth over which the repeater 1106 transmits the signal to the UE 1108 may be a sub-THz frequency bandwidth.

In an aspect, the second frequency bandwidth is an mmW frequency bandwidth. For example, referring to FIG. 11, the second frequency bandwidth over which the repeater 1106 receives the signal may be a mmW frequency bandwidth.

FIG. 20 is a diagram 2000 illustrating an example of a hardware implementation for an apparatus 2004. The apparatus 2004 may be a UE, a component of a UE, or may implement UE functionality. In some aspects, the apparatus 2004 may include a cellular baseband processor 2024 (also referred to as a modem) coupled to one or more transceivers 2022 (e.g., cellular RF transceiver). The cellular baseband processor 2024 may include on-chip memory 2024′. In some aspects, the apparatus 2004 may further include one or more subscriber identity modules (SIM) cards 2020 and an application processor 2006 coupled to a secure digital (SD) card 2008 and a screen 2010. The application processor 2006 may include on-chip memory 2006′. In some aspects, the apparatus 2004 may further include a Bluetooth module 2012, a WLAN module 2014, an SPS module 2016 (e.g., GNSS module), one or more sensor modules 2018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2026, a power supply 2030, and/or a camera 2032. The Bluetooth module 2012, the WLAN module 2014, and the SPS module 2016 may include an on-chip transceiver (TRX) (or in some cases, just a receiver (RX)). The Bluetooth module 2012, the WLAN module 2014, and the SPS module 2016 may include their own dedicated antennas and/or utilize the antennas 2080 for communication. The cellular baseband processor 2024 communicates through the transceiver(s) 2022 via one or more antennas 2080 with the UE 104 and/or with an RU associated with a network entity 2002. The cellular baseband processor 2024 and the application processor 2006 may each include a computer-readable medium/memory 2024′, 2006′, respectively. The additional memory modules 2026 may also be considered a computer-readable medium/memory. Each computer-readable medium/memory 2024′, 2006′, 2026 may be non-transitory. The cellular baseband processor 2024 and the application processor 2006 are each responsible for general processing, including the execution of software stored on the computer-readable medium/memory. The software, when executed by the cellular baseband processor 2024/application processor 2006, causes the cellular baseband processor 2024/application processor 2006 to perform the various functions described supra. The computer-readable medium/memory may also be used for storing data that is manipulated by the cellular baseband processor 2024/application processor 2006 when executing software. The cellular baseband processor 2024/application processor 2006 may be a component of the UE 350 and may include the memory 360 and/or at least one of the TX processor 368, the RX processor 356, and the controller/processor 359. In one configuration, the apparatus 2004 may be a processor chip (modem and/or application) and include just the cellular baseband processor 2024 and/or the application processor 2006, and in another configuration, the apparatus 2004 may be the entire UE (e.g., see 350 of FIG. 3) and include the additional modules of the apparatus 2004.

As discussed supra, the component 198 is configured to precode data based on a space-frequency precoding scheme across a plurality of spatial ports and virtual ports based on frequency over which the data is to be transmitted and to transmit, to a repeater, the space-frequency precoded data via the plurality of spatial ports and layers associated with the virtual ports. The component 198 may also be configured to receive a signal from a repeater comprising data precoded based on a space-frequency precoding scheme across a plurality of spatial ports and virtual ports and to derive separate virtual data streams by applying space-frequency MMSE combining of the received signal across multiple reception ports. The component 198 may be further configured to perform any of the aspects described in connection with the flowchart in FIGS. 13-16 and/or the aspects performed by the UE 1108 and 1208 in the communication flows in FIGS. 11 and 12. The component 198 may be within the cellular baseband processor 2024, the application processor 2006, or both the cellular baseband processor 2024 and the application processor 2006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2004 may include a variety of components configured for various functions. In one configuration, the apparatus 2004, and in particular the cellular baseband processor 2024 and/or the application processor 2006, includes means for precoding data based on a space-frequency precoding scheme across a plurality of spatial ports and virtual ports based on frequency over which the data is to be transmitted and means for transmitting, to a repeater, the space-frequency precoded data via the plurality of spatial ports and layers associated with the virtual ports. In another configuration, the apparatus 2004, and in particular the cellular baseband processor 2024 and/or the application processor 2006, includes means for receiving a signal from a repeater comprising data precoded based on a space-frequency precoding scheme across a plurality of spatial ports and virtual ports and means for deriving separate virtual data streams by applying space-frequency MMSE combining of the received signal across multiple reception ports. The means may be the component 198 of the apparatus 2004 configured to perform the functions recited by the means. As described supra, the apparatus 2004 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 21 is a diagram 2100 illustrating an example of a hardware implementation for a network entity 2102. The network entity 2102 may be a BS, a component of a BS, or may implement BS functionality. The network entity 2102 may include at least one of a CU 2110, a DU 2130, or an RU 2140. For example, depending on the layer functionality handled by the component 199, the network entity 2102 may include the CU 2110; both the CU 2110 and the DU 2130; each of the CU 2110, the DU 2130, and the RU 2140; the DU 2130; both the DU 2130 and the RU 2140; or the RU 2140. The CU 2110 may include a CU processor 2112. The CU processor 2112 may include on-chip memory 2112′. In some aspects, the CU 2110 may further include additional memory modules 2114 and a communications interface 2118. The CU 2110 communicates with the DU 2130 through a midhaul link, such as an F1 interface. The DU 2130 may include a DU processor 2132. The DU processor 2132 may include on-chip memory 2132′. In some aspects, the DU 2130 may further include additional memory modules 2134 and a communications interface 2138. The DU 2130 communicates with the RU 2140 through a fronthaul link. The RU 2140 may include an RU processor 2142. The RU processor 2142 may include on-chip memory 2142′. In some aspects, the RU 2140 may further include additional memory modules 2144, one or more transceivers 2146, antennas 2180, and a communications interface 2148. The RU 2140 communicates with the UE 104. The on-chip memory 2112′, 2132′, 2142′ and the additional memory modules 2114, 2134, 2144 may each be considered a computer-readable medium/memory. Each computer-readable medium/memory may be non-transitory. Each of the processors 2112, 2132, 2142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to precode data based on a space-frequency precoding scheme across a plurality of spatial ports and virtual ports based on frequency over which the data is to be transmitted and to transmit, to a repeater, the space-frequency precoded data via the plurality of spatial ports and layers associated with the virtual ports. The component 199 may also be configured to receive a signal from a repeater comprising data precoded based on a space-frequency precoding scheme across a plurality of spatial ports and virtual ports and to derive separate virtual data streams by applying space-frequency MMSE combining of the received signal across multiple reception ports. The component 199 may be further configured to perform any of the aspects described in connection with the flowchart in FIGS. 13-16 and/or the aspects performed by the network node 1102 and 1202 in the communication flows in FIGS. 11 and 12. The component 199 may be within one or more processors of one or more of the CU 2110, DU 2130, and the RU 2140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2102 may include a variety of components configured for various functions. In one configuration, the network entity 2102 includes means for precoding data based on a space-frequency precoding scheme across a plurality of spatial ports and virtual ports based on frequency over which the data is to be transmitted and means for transmitting, to a repeater, the space-frequency precoded data via the plurality of spatial ports and layers associated with the virtual ports. In another configuration, the network entity 2102 includes means for receiving a signal from a repeater comprising data precoded based on a space-frequency precoding scheme across a plurality of spatial ports and virtual ports and means for deriving separate virtual data streams by applying space-frequency MMSE combining of the received signal across multiple reception ports. The means may be the component 199 of the network entity 2102 configured to perform the functions recited by the means. As described supra, the network entity 2102 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 22 is a diagram 2200 illustrating an example of a hardware implementation for a network entity 2260. In one example, the network entity 2260 may be a repeater. The network entity 2260 may include a network processor 2212. The network processor 2212 may include on-chip memory 2212′. In some aspects, the network entity 2260 may further include additional memory modules 2214. The network entity 2260 communicates via the network interface 2280 directly (e.g., backhaul link) or indirectly (e.g., through a RIC) with the CU 2202. The network entity 2260 may also communicate with the UE 104 via the network interface 2280 (e.g., in an aspect in which the network entity 2260 is an access point). The on-chip memory 2212′ and the additional memory modules 2214 may each be considered a computer-readable medium/memory. Each computer-readable medium/memory may be non-transitory. The processor 2212 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, in an aspect, the component 2204 is configured to receive, over a first frequency bandwidth, a signal from a first wireless device, the signal comprising data precoding based on a space-frequency precoding scheme across a plurality of spatial ports and virtual ports and to forward, without decoding, the signal to a second wireless device over a second frequency bandwidth as a line-of-sight (LOS) multiple-input and multiple-output (MIMO) signal. In another aspect, the component 2204 is configured to receive, from a repeater, a signal comprising data precoded based on a space-frequency precoding scheme across a plurality of spatial ports and virtual ports, the signal received as a line-of-sight (LOS) multiple-input and multiple-output (MIMO) over a second frequency bandwidth, to recompose the signal to the first frequency bandwidth, and to transmit the signal to the UE over the first frequency bandwidth. The component 2204 may be further configured to perform any of the aspects described in connection with the flowchart in FIGS. 17-19 and/or the aspects performed by the repeaters 1104, 1106, 1204, and 1206 in the communication flows in FIGS. 11 and 12 As shown in FIG. 22, the component 2204 may be within the processor 2212. The component 2204 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2260 may include a variety of components configured for various functions. In one configuration, the network entity 2260 includes means for receiving, over a first frequency bandwidth, a signal from a first wireless device, the signal comprising data precoding based on a space-frequency precoding scheme across a plurality of spatial ports and virtual ports and means for forwarding, without decoding, the signal to a second wireless device over a second frequency bandwidth as a line-of-sight (LOS) multiple-input and multiple-output (MIMO) signal. In another configuration, the network entity 2260 may include means for receiving, from a repeater, a signal comprising data precoded based on a space-frequency precoding scheme across a plurality of spatial ports and virtual ports, the signal received as a line-of-sight (LOS) multiple-input and multiple-output (MIMO) over a second frequency bandwidth, recomposing the signal to the first frequency bandwidth, and transmitting the signal to the UE over the first frequency bandwidth The means may be the component 2204 of the network entity 2260 configured to perform the functions recited by the means.

Various aspects relate generally to wireless communication and more particularly to space-frequency precoding for hybrid frequency multi-hop links. The multi-hop links may be implemented utilizing LOS MIMO-based repeaters. Some aspects more specifically relate to performing space-frequency precoding and combining at the transmit and receive edges (e.g., at the network node or UE rather than at the repeaters). For instance, when transmitting a data signal, the network node may precode the data signal based on a space-frequency precoding scheme across a plurality of spatial ports and virtual ports based on a first frequency bandwidth (e.g., a sub-THz frequency bandwidth) over which the data is to be transmitted. The network node may transmit the space-frequency precoded data signal to a first repeater via the plurality of spatial ports and virtual ports. The first repeater may forward the space-frequency precoded data signal to a second repeater over a second frequency bandwidth (e.g., a mmW frequency bandwidth) as an LOS MIMO signal. The second repeater may recompose the space-frequency precoded data signal back to the first frequency bandwidth and transmit the recomposed data signal to the UE over the first frequency bandwidth. The UE may apply space-frequency MMSE combining across the receive ports by which the recomposed space-frequency precoded data signal is received.

Particular aspects of the subject matter described in this disclosure can be implemented to realize one or more of the following potential advantages. In some examples, by applying space-frequency precoding/combining at the transmit and receive edges rather than at the repeaters (i.e., at the intermediate hops), power intensive digital processing at the repeaters may be avoided. Accordingly, analog repeaters may be utilized instead, which consume less power. As such, the aspects described herein advantageously achieve a more power-efficient Sub-THz deployment, as overall power consumption is reduced as a result from using analog repeaters at the intermediate hops. Moreover, by applying space-frequency precoding across the spatial and frequency transmit ports and applying space-frequency combining across the spatial and frequency receive ports at the transmit and receive edges, respectively, inter-channel leakage and/or interference related to the LOS MIMO usage at the intermediate hops is mitigated.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, including precoding data based on a space-frequency precoding scheme across a plurality of spatial ports and virtual ports based on frequency over which the data is to be transmitted; and transmitting, to a repeater, the space-frequency precoded data via the plurality of spatial ports and layers associated with the virtual ports.

Aspect 2 is the method of aspect 1, where precoding the data based on the space-frequency precoding scheme includes decomposing a frequency dimension into a plurality of frequency segments, wherein each of the plurality of frequency segments corresponds to at least one of the virtual ports; decomposing the data into a plurality of virtual data streams corresponding to the plurality of spatial ports and virtual ports based on the plurality of frequency segments; and applying a precoding matrix in accordance with the space-frequency precoding scheme to the plurality of virtual data streams across the plurality of spatial ports and virtual ports based on the plurality of frequency segments.

Aspect 3 is the method of aspect 2, where each of the plurality of frequency segments comprises two polarizations applied in combination with the plurality of spatial ports and virtual ports.

Aspect 4 is the method of aspect 3, where a first of the two polarizations is a horizontal polarization, and a second of the two polarizations is a vertical polarization.

Aspect 5 is the method of any of aspects 2 to 4, further including: transmitting or receiving signaling further indicating at least one of: a frequency segment size of each of the plurality of frequency segments; a virtualization factor based on a LOS MIMO order utilized by the repeater; and a guard band size of a respective guard band between each of the plurality of frequency segments.

Aspect 6 is the method of aspect 5, where the virtualization factor comprises at least one of: a first number of the plurality of virtual data streams supported by the repeater, or a second number of the plurality of spatial ports and virtual ports supported by the repeater.

Aspect 7 is the method of any of aspects 1 to 6, where the wireless device is a network node, the method further including receiving an indication of support for the space-frequency precoding scheme.

Aspect 8 is the method of any of aspects 1 to 6, where the wireless device is a UE, the method further including transmitting an indication of support for the space-frequency precoding scheme.

Aspect 9 is the method of any of aspects 1 to 8, where the space-frequency precoded data is transmitted via the plurality of spatial ports and layers associated with the virtual ports over a sub-THz frequency band.

Aspect 10 is the method of any of aspects 1 to 5, 8, and 9, where the wireless device is a UE, the method further comprising receiving signaling that indicates that the space-frequency precoding scheme is to be applied on data transmitted by the UE.

Aspect 11 is the method of any of aspects 1 to 7 and 9, where the wireless device is a network node, the method further including receiving signaling indicating a factor based on an LOS MIMO order utilized by the repeater to forward the space-frequency precoded data to an additional wireless device.

Aspect 12 is a method of wireless communication at a wireless device, including receiving a signal from a repeater comprising data precoded based on a space-frequency precoding scheme across a plurality of spatial ports and virtual ports; and deriving separate virtual data streams by applying space-frequency MMSE combining of the received signal across multiple reception ports.

Aspect 13 is the method of aspect 12, further including decomposing, prior to the space-frequency MMSE combining, frequency dimensions of the signal into virtual frequency segments of the signal, where each virtual frequency segment corresponds to a virtual reception port comprised in the multiple reception ports.

Aspect 14 is the method of aspect 13, where each of the virtual frequency segments comprises two polarizations applied in combination with the plurality of spatial ports and virtual ports.

Aspect 15 is the method of aspect 14, where a first of the two polarizations is a horizontal polarization, and a second of the two polarizations is a vertical polarization.

Aspect 16 is the method of any of aspects 12 to 15, where the wireless device is a UE, the method further including transmitting an indication of support for the space-frequency precoding scheme prior to receiving the signal.

Aspect 17 is the method of any of aspects 12 to 16, further including receiving signaling that indicates at least that the space-frequency precoding scheme is applied to the signal.

Aspect 18 is the method of any of aspects 13 to 18, further including receiving signaling that indicates at least one of: a frequency segment size of each of the virtual frequency segments; a virtualization factor based on a LOS MIMO order utilized by the repeater; and a guard band size of a respective guard band between each of the virtual frequency segments.

Aspect 19 is the method of aspect 18, where the virtualization factor comprises at least one of: a first number of a plurality of virtual data streams supported by the repeater, or a second number of the plurality of spatial ports and virtual ports supported by the repeater.

Aspect 20 is the method of any of aspects 12 to 19, where the wireless device is a UE that receives the signal from a network node via the repeater.

Aspect 21 is the method of any of aspects 12 to 15 and 17 to 19, where the wireless device is a network node that receives the signal from a UE via the repeater.

Aspect 22 is the method of any of aspects 13 to 21, where the data is received via the multiple reception ports over a sub-THz frequency band.

Aspect 23 is a method of wireless communication at a repeater, including: receiving, over a first frequency bandwidth, a signal from a first wireless device, the signal comprising data precoding based on a space-frequency precoding scheme across a plurality of spatial ports and virtual ports; and forwarding, without decoding, the signal to a second wireless device over a second frequency bandwidth as a line-of-sight (LOS) multiple-input and multiple-output (MIMO) signal.

Aspect 24 is the method of aspect 23, further including signaling a factor based on an LOS MIMO order utilized by the repeater to forward the signal to the second wireless device.

Aspect 25 is the method of any of aspects 23 to 24, further including receiving signaling indicating at least one of a first number of beamformers to be utilized by the repeater or a second number of LOS MIMO transmitters to be utilized by the repeater, the first number and the second number being based on an allocation of the first frequency bandwidth by a user equipment (UE) for which the signal is intended.

Aspect 26 is the method of any of aspects 23 to 25, where the repeater is an analog repeater.

Aspect 27 is the method of any of aspects 23 to 26, where the first wireless device is a network node and the second wireless device is an AP.

Aspect 28 is the method of any of aspects 23 to 26, where the first wireless device is a UE and the second wireless device is an additional repeater.

Aspect 29 is a method of wireless communication at an AP that supports multiple hop wireless communication for a UE over a first frequency bandwidth. The method includes: receiving, from a repeater, a signal comprising data precoded based on a space-frequency precoding scheme across a plurality of spatial ports and virtual ports, the signal received as an LOS MIMO over a second frequency bandwidth; recomposing the signal to the first frequency bandwidth; or transmitting the signal to the UE over the first frequency bandwidth.

Aspect 30 is the method of aspect 29, where the first frequency bandwidth is a sub-THz frequency bandwidth, and where the second frequency bandwidth is a millimeter wave bandwidth.

Aspect 31 is an apparatus for wireless communication at a wireless device. The apparatus includes memory; and at least one processor coupled to the memory and, based at least in part on information stored in the memory, the at least one processor is configured to implement any of aspects 1 to 11.

Aspect 32 is the apparatus of aspect 31, further including at least one of a transceiver or an antenna coupled to the at least one processor.

Aspect 33 is an apparatus for wireless communication at a wireless device. The apparatus includes memory; and at least one processor coupled to the memory and, based at least in part on information stored in the memory, the at least one processor is configured to implement any of aspects 12 to 22.

Aspect 34 is the apparatus of aspect 33, further including at least one of a transceiver or an antenna coupled to the at least one processor.

Aspect 35 is an apparatus for wireless communication at a repeater. The apparatus includes memory; and at least one processor coupled to the memory and, based at least in part on information stored in the memory, the at least one processor is configured to implement any of aspects 23 to 28.

Aspect 36 is the apparatus of aspect 35, further including at least one of a transceiver or an antenna coupled to the at least one processor.

Aspect 37 is an apparatus for wireless communication at a repeater. The apparatus includes memory; and at least one processor coupled to the memory and, based at least in part on information stored in the memory, the at least one processor is configured to implement any of aspects 29 to 30.

Aspect 38 is the apparatus of aspect 37, further including at least one of a transceiver or an antenna coupled to the at least one processor.

Aspect 39 is an apparatus for wireless communication including means for implementing any of aspects 1 to 11.

Aspect 40 is an apparatus for wireless communication including means for implementing any of aspects 12 to 22.

Aspect 41 is an apparatus for wireless communication including means for implementing any of aspects 23 to 28.

Aspect 42 is an apparatus for wireless communication including means for implementing any of aspects 29 to 30.

Aspect 43 is a computer-readable medium (e.g., a non-transitory computer-readable medium) storing computer executable code, the code when executed by at least one processor causes the at least one processor to implement any of aspects 1 to 11.

Aspect 44 is a computer-readable medium (e.g., a non-transitory computer-readable medium) storing computer executable code, the code when executed by at least one processor causes the at least one processor to implement any of aspects 12 to 22.

Aspect 45 is a computer-readable medium (e.g., a non-transitory computer-readable medium) storing computer executable code, the code when executed by at least one processor causes the at least one processor to implement any of aspects 23 to 28.

Aspect 46 is a computer-readable medium (e.g., a non-transitory computer-readable medium) storing computer executable code, the code when executed by at least one processor causes the at least one processor to implement any of aspects 29 to 30.

What is claimed is:

1. An apparatus of wireless communication at a wireless device, comprising:
memory; and
at least one processor coupled to the memory and, based at least in part on information stored in the memory, the at least one processor is configured to:
precode data based on a space-frequency precoding scheme across a plurality of spatial ports and virtual ports based on frequency over which the data is to be transmitted; and
transmit, to a repeater, the space-frequency precoded data via the plurality of spatial ports and layers associated with the virtual ports.

2. The apparatus of claim 1, wherein to precode the data based on the space-frequency precoding scheme, the at least one processor is configured to:
decompose a frequency dimension into a plurality of frequency segments, wherein each of the plurality of frequency segments corresponds to at least one of the virtual ports;
decompose the data into a plurality of virtual data streams corresponding to the plurality of spatial ports and virtual ports based on the plurality of frequency segments; and
applying a precoding matrix in accordance with the space-frequency precoding scheme to the plurality of virtual data streams across the plurality of spatial ports and virtual ports based on the plurality of frequency segments.

3. The apparatus of claim 2, wherein each of the plurality of frequency segments comprises two polarizations applied in combination with the plurality of spatial ports and virtual ports.

4. The apparatus of claim 3, wherein a first of the two polarizations is a horizontal polarization, and a second of the two polarizations is a vertical polarization.

5. The apparatus of claim 2, wherein the at least one processor is further configured to:
transmit or receive signaling further indicating at least one of:
a frequency segment size of each of the plurality of frequency segments;
a virtualization factor based on a line-of-sight (LOS) multiple-input and multiple-output (MIMO) order utilized by the repeater; and
a guard band size of a respective guard band between each of the plurality of frequency segments.

6. The apparatus of claim 5, wherein the virtualization factor comprises at least one of:
a first number of the plurality of virtual data streams supported by the repeater; or
a second number of the plurality of spatial ports and virtual ports supported by the repeater.

7. The apparatus of claim 1, wherein the wireless device is a network node, the at least one processor being further configured to:
receive an indication of support for the space-frequency precoding scheme.

8. The apparatus of claim 1, wherein the wireless device is a user equipment (UE), the at least one processor being further configured to:
transmit an indication of support for the space-frequency precoding scheme.

9. The apparatus of claim 1, wherein the at least one processor is configured to transmit the space-frequency precoded data via the plurality of spatial ports and layers associated with the virtual ports over a sub-terahertz (sub-THz) frequency band.

10. The apparatus of claim 1, wherein the wireless device is a user equipment (UE), the at least one processor being further configured to:
receive signaling that indicates that the space-frequency precoding scheme is to be applied on data transmitted by the UE.

11. The apparatus of claim 1, wherein the wireless device is a network node, the at least one processor being further configured to:
receive signaling indicating a factor based on an LOS MIMO order utilized by the repeater to forward the space-frequency precoded data to an additional wireless device.

12. An apparatus of wireless communication at a wireless device, comprising:
memory; and
at least one processor coupled to the memory and, based at least in part on information stored in the memory, the at least one processor is configured to:
receive a signal from a repeater comprising data precoded based on a space-frequency precoding scheme across a plurality of spatial ports and virtual ports; and
derive separate virtual data streams by applying a space-frequency minimum mean square error (MMSE) combining of the received signal across multiple reception ports.

13. The apparatus of claim 12, wherein the at least one processor is further configured to:
decompose, prior to the space-frequency MMSE combining, frequency dimensions of the signal into virtual frequency segments of the signal, where each virtual frequency segment corresponds to a virtual reception port comprised in the multiple reception ports.

14. The apparatus of claim 13, wherein each of the virtual frequency segments comprises two polarizations applied in combination with the plurality of spatial ports and virtual ports.

15. The apparatus of claim 14, wherein a first of the two polarizations is a horizontal polarization, and a second of the two polarizations is a vertical polarization.

16. The apparatus of claim 12, wherein the wireless device is a user equipment (UE), the at least one processor being further configured to:
transmit an indication of support for the space-frequency precoding scheme prior to receiving the signal.

17. The apparatus of claim 12, wherein the at least one processor is further configured to:
receive signaling that indicates at least that the space-frequency precoding scheme is applied to the signal.

18. The apparatus of claim 13, wherein the at least one processor is further configured to: receive signaling that indicates at least one of:
a frequency segment size of each of the virtual frequency segments;
a virtualization factor based on a line-of-sight (LOS) multiple-input and multiple-output (MIMO) order utilized by the repeater; and
a guard band size of a respective guard band between each of the virtual frequency segments.

19. The apparatus of claim 18, wherein the virtualization factor comprises at least one of:
a first number of a plurality of virtual data streams supported by the repeater; or
a second number of the plurality of spatial ports and virtual ports supported by the repeater.

20. The apparatus of claim 12, wherein the wireless device is a user equipment (UE), the at least one processor being configured to receive the signal from a network node via the repeater.

21. The apparatus of claim 12, wherein the wireless device is a network node, the at least one processor being configured to receive the signal from a user equipment (UE) via the repeater.

22. The apparatus of claim 13, wherein the at least one processor is configured to receive the data via the multiple reception ports over a sub-terahertz (sub-THz) frequency band.

23. An apparatus of wireless communication at a repeater, comprising:
memory; and
at least one processor coupled to the memory and, based at least in part on information stored in the memory, the at least one processor is configured to:
receive, over a first frequency bandwidth, a signal from a first wireless device, the signal comprising data precoding based on a space-frequency precoding scheme across a plurality of spatial ports and virtual ports; and
forward, without decoding, the signal to a second wireless device over a second frequency bandwidth as a line-of-sight (LOS) multiple-input and multiple-output (MIMO) signal.

24. The apparatus of claim 23, wherein the at least one processor is further configured to:
signal a factor based on an LOS MIMO order utilized by the repeater to forward the signal to the second wireless device.

25. The apparatus of claim 23, wherein the at least one processor is further configured to:
receive signaling indicating at least one of a first number of beamformers to be utilized by the repeater or a second number of LOS MIMO transmitters to be utilized by the repeater, the first number and the second number being based on an allocation of the first frequency bandwidth by a user equipment (UE) for which the signal is intended.

26. The apparatus of claim 23, wherein the repeater is an analog repeater.

27. The apparatus of claim 23, wherein the first wireless device is a network node and the second wireless device is an access point (AP).

28. The apparatus of claim 23, wherein the first wireless device is a user equipment (UE) and the second wireless device is an additional repeater.

29. An apparatus of wireless communication at an access point (AP) that supports multiple hop wireless communication for a user equipment (UE) over a first frequency bandwidth, the apparatus comprising:
memory; and
at least one processor coupled to the memory and, based at least in part on information stored in the memory, the at least one processor is configured to:
receive, from a repeater, a signal comprising data precoded based on a space-frequency precoding scheme across a plurality of spatial ports and virtual ports, the signal received as a line-of-sight (LOS) multiple-input and multiple-output (MIMO) over a second frequency bandwidth;
recompose the signal to the first frequency bandwidth; and
transmit the signal to the UE over the first frequency bandwidth.

30. The apparatus of claim 29, wherein the first frequency bandwidth is a sub-terahertz (sub-THz) frequency bandwidth, and wherein the second frequency bandwidth is a millimeter wave bandwidth.
